(19) United States
(12) Patent Application Publication
(10) Pub. No.: US 2007/0129484 A1
(43) Pub. Date: Jun. 7, 2007

(54) Polyoxymethylene resin composition and moldings thereof

(75) Inventors: Mitsuhiro Horio, Kurashiki-shi (JP); Yuuji Yoshinaga, Kurashiki-shi (JP)

Correspondence Address: GREENBLUM & BERNSTEIN, P.L.C., 1950 ROLAND CLARKE PLACE, RESTON, VA, 20191, US

(73) Assignee: ASAHI KASEI CHEMICALS CORPORATION, TOKYO (JP)

(21) Appl. No.: 10/574,837

(22) PCT Filed: Oct. 8, 2004
(86) PCT No.: PCT/JP04/14925

§ 371 Date: Apr. 6, 2006

(30) Foreign Application Priority Data
Oct. 10, 2003 (JP) 2003-351730

(51) Int. Cl. C08L 53/00

(52) U.S. Cl. 524/505

(57) ABSTRACT

A polyoxymethylene resin composition which comprises (A) a polyoxymethylene resin, (B) a polymer having at least one block made of a hydrogenated aromatic vinyl/conjugated diene random copolymer having the main dispersion peak of tan δ at 60° C. or below in the viscoelastic spectrum, and, if necessary, (C) a polyolefin resin with the provisos that the amount of (A) is 10 to 99.5 parts by weight and the total amount of (B) and (C) is 0.5 to 90 parts by weight, each per 100 parts by weight of the sum of (A), (B) and (C) and that the (B)/(C) weight ratio is 100/0 to 20/80.

### TECHNICAL FIELD

The present invention relates to a resin composition obtained by imparting excellent flexibility, vibration-damping and sound-damping properties, frictional wear properties under a heavy load and oil resistance to a polyoxymethylene resin. The resin composition of the invention is suitable for the parts of precision machinery and tools, OA (office automation) appliances, automobiles, industrial materials, sundries and the like.

### BACKGROUND ART

Polyoxymethylene resins are commonly used in various working parts, OA appliances and the like as engineering resins having balanced mechanical properties and excellent frictional wear properties. The polyoxymethylene resins, however, are not sufficient in flexibility and impact resistance. Therefore, attempts are made to produce a composition comprising a polyoxymethylene resin and an elastomer. Specifically, there has been disclosed, for example, a technique for blending a polyoxymethylene resin with a polyurethane resin (for example, patent document 1 (corresponding to patent document 2) and patent document 3 (corresponding to patent document 4)); a technique for blending a polyoxymethylene resin with an olefin elastomer and a polyurethane (for example, patent document 5 (corresponding to patent document 6)); a technique for blending a polyacetal resin with a multi-layer interpolymer and a thermoplastic polyurethane (for example, patent document 7 (corresponding to patent document 8)); and a technique for blending a polyoxymethylene with a thermoplastic polyurethane and a polyether block copolyamide (for example, patent document 9 (corresponding to patent document 10)). Of these techniques, the technique comprising adding a polyurethane is commonly used in practice. Such compositions, however, have no vibration-damping properties and are very poor in sliding properties. Therefore, they have not been used for vibration damping and sound damping.

For vibration damping and sound damping, a composition comprising a polyacetal resin and a resin comprising thermoplastic polyurethane blocks and blocks made of conjugated diene units and aromatic vinyl compound units (for example, patent document 11) has been disclosed with respect to a technique for adding a resin having vibration-damping properties. However, although this material has vibration-damping properties, it is insufficient in sound-damping effect because of its low sliding properties. Regarding a technique for solving the above problem, a composition comprising a polyoxymethylene resin, a high-molecular weight compound having a main dispersion peak of tan 5 at 60° C. or below and a silicone-grafted polyolefin resin (patent document 12 (corresponding to patent document 13)) has been proposed. In this reference, a polymer obtained from an aromatic vinyl compound and a copolymerizable diene monomer is described as the high-molecular weight compound having the main dispersion peak of tan δ at 60° C. or below. As preferable examples of this polymer, block polymers comprising styrene segments (a) and segments (b) made of isoprene or isoprene-butadiene are described therein and the same block polymers as above are used in working examples. By using such a block polymer and improving sliding properties by the addition of a silicone component, sufficient vibration-damping and sound-damping effects can be obtained but sufficient shaft hole fusion properties under a heavy load and oil resistance cannot be obtained.

On the other hand, the polymer having at least one block made of a hydrogenated aromatic vinyl compound-conjugated diene compound random copolymer, which is used in the invention, is the polymer described in patent document 14. This reference also describes polyoxymethylene resins as resins capable of giving a composition but does not give any specific example (including working examples).
Patent document 1: JP-A-59-155453
Patent document 2: U.S. Pat. No. 4,804,716
Patent document 3: JP-A-59-145243
Patent document 4: U.S. Pat. No. 4,978,725
Patent document 5: JP-A-54-155248
Patent document 6: U.S. Pat. No. 4,277,577
Patent document 7: JP-A-62-036451
Patent document 8: U.S. Pat. No. 4,665,126
Patent document 9: JP-A-63-280758
Patent document 10: European Patent No. 290761
Patent document 11: JP-A-9-310017
Patent document 12: JP-A-2002-194178
Patent document 13: U.S. Pat. No. 6,750,287
Patent document 14: WO 03/035705

### DISCLOSURE OF THE INVENTION

An object of the invention is to provide a resin composition obtained by imparting excellent flexibility, vibration-damping and sound-damping properties, frictional wear properties under a heavy load and oil resistance to a polyoxymethylene resin. Another object of the invention is to provide a molded article obtained by molding and/or cutting the resin composition.

The inventors investigated various high-molecular weight compounds, lubricants and the like in order to impart excellent flexibility, vibration-damping and sound-damping properties, frictional wear properties under a heavy load and oil resistance to a polyoxymethylene resin, and consequently have accomplished the invention. The composition of the invention is suitably used in the electric and electronic parts of OA appliances, VTR (video tape recorder) appliances, music•image•information appliances, communication appliances and the like, internal and external automobile trims, and industrial sundries.

That is, the invention relates to the following items 1 to 8.

1. A polyoxymethylene resin composition comprising

(A) a polyoxymethylene resin;
(B) a polymer having at least one block made of a hydrogenated aromatic vinyl compound-conjugated diene compound random copolymer having the main dispersion peak of tan δ at 60° C. or below in the viscoelastic spectrum, and optionally
(C) a polyolefin resin, wherein the amount of (A) ranges from 10 to 99.5 parts by weight and the total amount of (B) and (C) ranges from 0.5 to 90 parts by weight, each per 100 parts by weight of the sum of (A), (B) and (C), and the (B)/(C) weight ratio ranges from 100/0 to 20/80.
   2. A polyoxymethylene resin composition according to the above item 1, which further comprises (D) a silicone-grafted polyolefin resin in an amount of 0.1 to 30 parts by weight per 100 parts by weight of the sum of (A), (B) and (C).
   3. A polyoxymethylene resin composition according to the above item 1 or 2, which further comprises (E) a lubricant and/or (F) an inorganic filler in amounts of 0.05 to 20 parts by weight and 0.1 to 150 parts by weight, respectively, per 100 parts by weight of the sum of (A), (B) and (C).
   4. A polyoxymethylene resin composition according to any one of the above items 1 to 3, wherein the component (A), i.e., the polyoxymethylene resin, comprises a polyoxymethylene block copolymer (A-1) having a number average molecular weight of 10,000 to 500,000 and represented by the following formula (1): 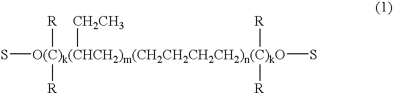
   wherein the portion other than S (hereinafter referred to as the block T) is a hydrogenated liquid polybutadiene residue having a hydroxyalkyl group at each end and having a number average molecular weight of 500 to 10,000 in which m=2 to 98 mole %, n=2 to 98 mole %, m+n=100 mole % and the units in an amount of m are present at random or in the form of a block(s) with respect to the units in an amount of n, the block T being able to be one which has unsaturated bonds and has an iodine number of 20 g−I₂/100 g or less; each of two k's, which may be the same or different, is an integer selected in the range of 2 to 6; each of R's, which may be the same or different, is a group selected from the group consisting of hydrogen, alkyl groups, substituted alkyl groups, aryl groups and substituted aryl groups; and the block S is a polyoxymethylene copolymer residue represented by the following formula (2): 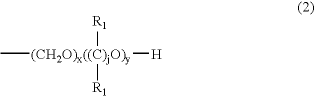
   wherein each of R₁'s, which may be the same or different, is a group selected from the group consisting of hydrogen, alkyl groups, substituted alkyl groups, aryl groups and substituted aryl groups; j is an integer selected in the range of 2 to 6; x=95 to 99.9 mole %, y=5 to 0.1 mole %, x+y=100 mole %; the units in an amount of y are present at random with respect to the units in an amount of x; and the average of the number average molecular weights of the two blocks S in the formula (1) is 5,000 to 250,000.
   5. A polyoxymethylene resin composition according to the above item (4), wherein as the component (A), i.e., the polyoxymethylene resin, the above-mentioned copolymer (A-1) and a polyoxymethylene copolymer (A-2) comprising oxymethylene groups as its main repeating units and comprising oxyalkylene groups of 2 or more carbon atoms in an amount of 0.1 to 10 mole % based on the number of moles of the oxymethylene groups are used in combination, and the (A-1)/(A-2) weight ratio of the polyoxymethylene block copolymer (A-1) to the polyoxymethylene copolymer (A-2) is 10 or more and less than 100.
   6. A polyoxymethylene resin composition according to any one of the above items 1 to 5, wherein the component (B), i.e., the polymer having at least one block made of a hydrogenated aromatic vinyl compound-conjugated diene compound random copolymer, is a block copolymer comprising at least one polymer block B1 comprising mainly aromatic vinyl compound units (the content of aromatic vinyl compound units: at least 90% by weight) and at least one aromatic vinyl compound-conjugated diene compound random copolymer block B2 (the content of aromatic vinyl compound units: less than 90% by weight and not less than 3% by weight), the content of aromatic vinyl compound units ranges from 50 to 90% by weight and the main dispersion peak of tan δ in the viscoelastic spectrum is at a temperature in the range of 60° C. to −30° C.
   7. A polyoxymethylene resin composition according to any one of the above items 1 to 6, wherein the component (C), i.e., the polyolefin resin, is a modified product obtained by modification with an α, β-unsaturated carboxylic acid and/or an acid anhydride thereof.
   8. A molded article obtained by molding, cutting, or both molding and cutting of a polyoxymethylene resin composition of any one of the above items 1 to 7.

### BEST MODE FOR CARRYING OUT THE INVENTION

The polyoxymethylene resin used as the component (A) in the invention is at least one member selected from the group consisting of homopolymers obtained by polymerizing formaldehyde or a cyclic oligomer such as trioxane, i.e., a trimer of formaldehyde, or tetraoxane, i.e., a tetramer of formaldehyde, and blocking both ends of the resulting polymer with an ether or ester group; oxymethylene copolymers comprising oxyalkylene units of 2 to 8 carbon atoms in an amount of 0.1 to 40 mole % based on the number of moles of oxymethylene units, which are obtained by copolymerizing formaldehyde, trioxane, i.e., a trimer of formaldehyde, or tetraoxane, i.e., a tetramer of formaldehyde with ethylene oxide, propylene oxide, 1,3-dioxolane, formal of glycol, formal of diglycol, or the like; such oxymethylene resins which have a branched molecular chain; and oxymethylene block polymers comprising 50% by weight or more of segments comprising oxymethylene units and 50% by weight or less of other segments.

Of these, a preferable polyoxymethylene resin is a polyoxymethylene copolymer (A-2) comprising oxymethylene groups as its main repeating units and comprising oxyalkylene groups of 2 or more carbon atoms in an amount of 0.1 to 10 mole %, preferably 0.1 to 5 mole %, more preferably 0.2 to 3 mole %, based on the number of moles of the oxymethylene groups.

An especially preferable polyoxymethylene resin is a polyoxymethylene block copolymer (A-1) having a number average molecular weight of 10,000 to 500,000 and represented by the following formula (1). This polyoxymethylene block copolymer (A-1) can be produced by the process described in International Publication No. WO10/009213. 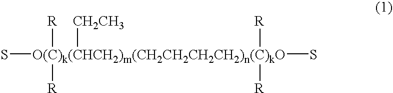
wherein the portion other than S (hereinafter referred to as the block T) is a hydrogenated liquid polybutadiene residue having a hydroxyalkyl group at each end and having a number average molecular weight of 500 to 10,000 in which m=2 to 98 mole %, n=2 to 98 mole %, m+n=100 mole % and the units in an amount of m are present at random or in the form of blocks with respect to the units in an amount of n, the block T being able to be one which has unsaturated bonds and an iodine number of 20 g−I₂/100 g or less; each of two k's, which may be the same or different, is an integer selected in the range of 2 to 6; each of R's, which may be the same or different, is a group selected from the group consisting of hydrogen, alkyl groups, substituted alkyl groups, aryl groups and substituted aryl groups; and the block S is a polyoxymethylene copolymer residue represented by the following formula (2): 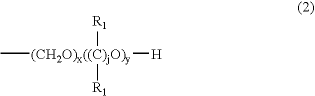
wherein each of R₁'s, which may be the same or different, is a group selected from the group consisting of hydrogen, alkyl groups, substituted alkyl groups, aryl groups and substituted aryl groups; j is an integer selected in the range of 2 to 6; x=95 to 99.9 mole %, y=5 to 0.1 mole %, x+y=100 mole %; the units in an amount of y are present at random with respect to the units in an amount of x; and the average of the number average molecular weights of the two blocks S in the formula (1) is 5,000 to 250,000.

The above-mentioned polyoxymethylene block copolymer (A-1) is effective in improving the miscibility with a polymer containing an olefin component. In this respect, using the copolymer (A-1) alone is the most effective. When the copolymer (A-1) is used in combination with the polyoxymethylene copolymer (A-2), it may be used in any (A-1)/(A-2) weight ratio in the range of 100/0 to 10/90, preferably 100/0 to 20/80, particularly preferably 100/0 to 30/70.

In addition, the melt flow rate (measured under the conditions according to ASTM-D1238-57T) of the polyoxymethylene resin used in the invention is 0.5 g/10 min or more from the viewpoint of molding processability and is 100 g/10 min, preferably 1.0 to 80 g/10 min, more preferably 5 to 60 g/10 min, most preferably 7 to 50 g/10 min, from the viewpoint of durability.

Stabilizers (e.g., heat stabilizers and weathering (light) stabilizers) added to conventional polyoxymethylene resins may be added alone or in combination to the polyoxymethylene resin of the invention. As the heat stabilizers, antioxidants, agents for capturing formaldehyde and formic acid, and combinations thereof are effective. As the antioxidants, hindered phenol type antioxidants are preferable.

The hindered phenol type antioxidants are, for example, n-octadecyl-3-(3′, 5′-di-t-butyl-4′-hydroxyphenyl)-propionate, n-octadecyl-3-(3′-methyl-5′-t-butyl-4′-hydroxyphenyl)-propionate, n-tetradecyl-3-(3′, 5′-di-t-butyl-4′-hydroxyphenyl)-propionate, 1,6-hexanediol-bis-(3-(3,5-di-t-butyl-4-hydroxyphenyl)-propionate), 1,4-butanediol-bis-(3-(3,5-di-t-butyl-4-hydroxyphenyl)-propionate) and triethylene glycol-bis-(3-(3-t-butyl-5-methyl-4-hydroxyphenyl)-propionate).

The hindered phenol type antioxidants also include tetrakis-(methylene-3-(3′, 5′-di-t-butyl-4′-hydroxyphenyl)propionatemethane, 3,9-bis(2-(3-(3-t-butyl-4-hydroxy-5-methylphenyl)propionyloxy)-1,1-dimethylethyl)-2,4,8,10-tetraoxaspiro(5,5)undecane, N,N′-bis-3-(3′,5′-di-t-butyl-4-hydroxyphenol)propionylhexamethylenediamine, N,N′-tetramethylenebis-3-(3′-methyl-5′-t-butyl-4-hydroxyphenol)propionyldiamine, N,N′-bis-(3-(3,5-di-t-butyl-4-hydroxyphenol) propionyl) hydrazine, N-salicyloyl-N′-salicylidenehydrazine, 3-(N-salicyloyl) amino-1,2,4-triazole, N,N′-bis(2-(3-(3,5-di-butyl-4-hydroxyphenyl)propionyloxy) ethyl) oxyamide and the like.

Of these hindered phenol type antioxidants, triethylene glycol-bis-(3-(3-t-butyl-5-methyl-4-hydroxyphenyl) -propionate) and tetrakis-(methylene-3-(3′,5′-di-t-butyl-4′-hydroxyphenyl)propionatemethane are preferable.

The agents for capturing formaldehyde and formic acid include (a) compounds and polymers, which contain nitrogen reactive with formaldehyde, and (b) hydroxides, inorganic acid salts and carboxylates of alkali metals and alkaline earth metals.

As the compounds and polymers, which contain nitrogen reactive with formaldehyde, of the item (a), there can be exemplified dicyandiamide, melamine, copolycondensation products of melamine and formaldehyde, polyamide resins (e.g., nylon 4-6, nylon 6, nylon 6-6, nylon 6-10, nylon 6-12, nylon 12, nylon 6/6-6, nylon 6/6-6/6-10 and nylon 6/6-12), poly-β-alanines and polyacrylamides. Of these, the copolycondensation products of melamine and formaldehyde, polyamide resins, poly-β-alanines and polyacrylamides are preferable, and the polyamide resins and poly-β-alanines are more preferable.

As the hydroxides, inorganic acid salts and carboxylates of alkali metals and alkaline earth metals of the item (b), there can be exemplified hydroxides of sodium, potassium, magnesium, calcium, barium and the like, and carbonates, phosphates, silicates, borates and carboxylates of the above-mentioned metals. Specifically, calcium salts are the most preferable and they include, for example, calcium hydroxide, calcium carbonate, calcium phosphate, calcium silicate, calcium borate and fatty acid calcium salts (e.g., calcium stearate and calcium myristate). The fatty acids may be substituted by a hydroxyl group(s). Of the above-exemplified calcium salts, the fatty acid calcium salts (e.g., calcium stearate and calcium myristate) are preferable.

As the weathering (light) stabilizers, (a) benzotriazole type substances, (b) anilide oxalate type substances and (c) hindered amine type substances are preferable.

The benzotriazole type substances of the item (a) include, for example, 2-(2′-hydroxy-5′-methyl-phenyl)benzotriazole, 2-(2′-hydroxy-3,5-di-t-butyl-phenyl)benzotriazole, 2-(2′-hydroxy-3,5-di-isoamyl-phenyl)benzotriazole, 2-[2′-hydroxy-3,5-bis-(α,α-dimethylbenzyl)phenyl]-2H-benzotriazole and 2-(2′-hydroxy-4′-octoxyphenyl)benzotriazole.

Preferable are 2-[2′-hydroxy-3,5-bis-(α,α-dimethylbenzyl)phenyl]-2H-benzotriazole and 2-(2′-hydroxy-3,5-di-t-butyl-phenyl)benzotriazole.

The anilide oxalate type substances of the item (b) include, for example, 2-ethoxy-2′-ethyloxalic acid bisanilide, 2-ethoxy-5-t-butyl-2′-ethyloxalic acid bisanilide and 2-ethoxy-3′-dodecyloxalic acid bisanilide. These substances may be used alone or in combination.

The hindered amine type substances of the item (c) include 4-acetoxy-2,2,6,6-tetramethylpiperidine, 4-stearoyloxy-2,2,6,6-tetramethylpiperidine, 4-acryloyloxy-2,2,6,6-tetramethylpiperidine, 4-(phenylacetoxy)-2,2,6,6-tetramethylpiperidine, 4-benzoyloxy-2,2,6,6-tetramethylpiperidine, 4-methoxy-2,2,6,6-tetramethylpiperidine, 4-stearyloxy-2,2,6,6-tetramethylpiperidine, 4-cyclohexyloxy-2,2,6,6-tetramethylpiperidine, 4-benzyloxy-2,2,6,6-tetramethylpiperidine, 4-phenoxy-2,2,6,6-tetramethylpiperidine, 4-(ethylcarbamoyloxy)-2,2,6,6-tetramethylpiperidine, 4-(cyclohexylcarbamoyloxy)-2,2,6,6-tetramethylpiperidine and 4-(phenylcarbamoyloxy)-2,2,6,6-tetramethylpiperidine.

The hindered amine type substances of the item (c) also include bis(2,2,6,6-tetramethyl-4-piperidine)-carbonate, bis(2,2,6,6-tetramethyl-4-piperidyl)-oxalate, bis(2,2,6,6- tetramethyl-4-piperidyl)-malonate, bis(2,2,6,6-tetramethyl-4-piperidyl)-sebacate, bis(2,2,6,6-tetramethyl-4-piperidyl)-adipate, bis(2,2,6,6-tetramethyl-4-piperidyl)-terephthalate, 1,2-bis(2,2,6,6-tetramethyl -4-piperidyloxy)-ethane and α,α′-bis(2,2,6,6-tetramethyl-4-piperidyloxy)-p-xylene.

The hindered amine type substances of the item (c) further include bis(2,2,6,6-tetramethyl-4-piperidyl)tolylene-2,4-dicarbamate, bis(2,2,6,6-tetramethyl-4-piperidyl)-hexamethylene-1,6-dicarbamate, tris(2,2,6,6-tetramethyl-4-piperidyl)-benzene-1,3,5-tricarboxylate, tris(2,2,6,6- tetramethyl-4-piperidyl)-benzene-1,3,4-tricarboxylate and the like. Preferable is bis(2,2,6,6-tetramethyl-4-piperidyl)-sebacate. The above-exemplified hindered amine type substances may be used alone or in combination.

Combinations of the above-exemplified benzotriazole type substances, anilide oxalate type substances and hindered amine type substances are the most preferable.

A preferable combination of stabilizers in the resin composition of the invention is a combination of “the hindered phenol (in particular, triethyleneglycol-bis-[3-(3-t-butyl-5-methyl-4-hydroxyphenyl)-propionate] or tetrakis-[methylene-3-(3′, 5′-di-t-butyl-4′-hydroxyphenyl)propionatemethane])”, “the polymer containing nitrogen reactive with formaldehyde (in particular, a polyamide resin or a poly-β-alanine)” and optionally “the fatty acid salt of an alkaline earth metal (in particular, a fatty acid calcium salt)”. As to the amounts of these stabilizers added, the amount of “the hindered phenol” added is preferably 0.05 to 0.5% by weight, the amount of “the polymer containing nitrogen reactive with formaldehyde” added is preferably 0.01 to 0.5% by weight and the amount of “the fatty acid salt of an alkaline earth metal (in particular, a fatty acid metal salt)” optionally added is preferably 0.01 to 0.3% by weight, each based on the weight of the polyoxymethylene resin. When the weathering (light) stabilizers are used, they are preferably used in an amount of 0.1 to 3% by weight.

The polymer having at least one block made of a hydrogenated aromatic vinyl compound-conjugated diene compound random copolymer, which is used as the component (B) in the resin composition of the invention, is that obtained by hydrogenating a polymer comprising one or more blocks formed by random copolymerization of an aromatic vinyl compound and a conjugated diene compound. Specific examples of the polymer used as the component (B) are (1) block copolymers comprising at least one polymer block B1 composed mainly of aromatic vinyl compound units (the content of aromatic vinyl compound units: at least 90% by weight) and at least one aromatic vinyl compound-conjugated diene compound random copolymer block B2 (the content of aromatic vinyl compound units: less than 90% by weight and not less than 3% by weight), (2) block copolymers comprising at least one polymer block B3 composed mainly of conjugated diene compound units (the content of conjugated diene compound units: at least 97% by weight) and at least one aromatic vinyl compound-conjugated diene compound random copolymer block B2 (the content of aromatic vinyl compound units: less than 90% by weight and not less than 3% by weight), (3) block copolymers comprising at least one polymer block B1 composed mainly of aromatic vinyl compound units (the content of aromatic vinyl compound units: at least 90% by weight), at least one aromatic vinyl compound-conjugated diene compound random copolymer block B2 (the content of aromatic vinyl compound units: less than 90% by weight and not less than 3% by weight) and at least one polymer block B3 composed mainly of conjugated diene compound units (the content of conjugated diene compound units: at least 97% by weight), and (4) aromatic vinyl compound-conjugated diene compound random copolymers.

The aromatic vinyl compound units in the random copolymer block in the above-mentioned block copolymer may be distributed either uniformly or taperingly. In addition, as the random copolymer blocks, a plurality of blocks having aromatic vinyl compound units uniformly distributed therein and/or a plurality of blocks having aromatic vinyl compound units taperingly distributed therein may be present. Furthermore, as the random copolymer blocks, a plurality of blocks having different aromatic vinyl compound unit contents may be present. As the block copolymers of the item (1), i.e., the block copolymers comprising a polymer block(s) B1 composed mainly of aromatic vinyl compound units and at least one aromatic vinyl compound-conjugated diene compound random copolymer block B2, block copolymers generally having any of the following structures can be exemplified:
(B1-B2)ₙ, B1-(B2-B1)ₙ-B2, B2-(B1-B2) ₙ₊₁, [(B1-B2)ₖ]ₘ₊₁-Z, [(B1-B2)ₖ-B1]ₘ₊₁-Z, [(B2-B1)ₖ]ₘ₊₁-Z, [(B2-B1)ₖ-B2]ₘ₊₁-Z
   wherein Z is a residue of a coupling agent or a residue of an initiator of polyfunctional organolithium compound, and each of n, k and m is an integer of 1 or more, in general, 1 to 5.

In addition, as the block copolymers of the item (2), i.e., block copolymers comprising at least one polymer block B3 composed mainly of conjugated diene compound units and at least one aromatic vinyl compound-conjugated diene compound random copolymer block B2, block copolymers generally having any of the following structures can be exemplified:
(B3-B2)ₙ, B3-(B2-B3)ₙ-B2, B2-(B3-B2)ₙ₊₁, [(B3-B2)ₖ]ₘ₊₁-Z, [(B3-B2)ₖ-B3]ₘ₊₁-Z, [(B2-B3)ₖ]ₘ₊₁-Z, [(B2-B3)ₖ-B2]ₘ₊₁-Z
   wherein Z is a residue of a coupling agent or a residue of an initiator of polyfunctional organolithium compound, and each of n, k and m is an integer of 1 or more, in general, 1 to 5.

Furthermore, as the bock copolymers of the item (3), i.e., block copolymers comprising at least one polymer block Bl composed mainly of aromatic vinyl compound units, at least one aromatic vinyl compound-conjugated diene compound random copolymer block B2 and at least one polymer block B3 composed mainly of conjugated diene compound units, block copolymers generally having any of the following structures can be exemplified:
(B1-B2-B3)ₙ, B1-(B2-B3) ₙ-B3, B3-(B1-B2)ₙ₊₁, [(B1-B2-B3)ₖ]ₘ₊₁-Z, [(B1-B2-B3)ₖ-B1]ₘ₊₁-Z, [(B2-B1-B3)ₖ]ₘ₊₁-Z, [(B2-B1)ₖ-B3]ₘ₊₁-Z
   wherein Z is a residue of a coupling agent or a residue of an initiator of polyfunctional organolithium compound, and each of n, k and m is an integer of 1 or more, in general, 1 to 5.

As the aromatic vinyl compound used in the polymer having at least one block made of any of the above-exemplified aromatic vinyl compound-conjugated diene compound random copolymers, there can be exemplified styrene, α-methylstyrene, p-methylstyrene, divinylbenzene, 1,1-diphenylethylene, N,N-dimethyl-p -aminoethylstyrene and N,N-diethyl-p-aminoethylstyrene. These may be used in combination and styrene is especially preferable. The conjugated diene is a diolefin having a pair of conjugated double bonds and includes, for example, 1,3-butadiene, 2-methyl-1,3-butadiene (isoprene), 2,3-dimethyl-1,3-butadiene, 1,3-pentadiene, 2-methyl-1,3- pentadiene and 1,3-hexadiene. Especially common examples thereof are 1,3-butadiene and isoprene. The above-exemplified conjugated dienes may be used in combination.

Usually, the content of aromatic vinyl compound units in the polymer having at least one block made of a hydrogenated aromatic vinyl compound-conjugated diene compound random copolymer may be properly chosen in the range of 3 to 90% by weight and is preferably 5 to 88% by weight, more preferably 10 to 86% by weight. When the content of aromatic vinyl compound units in the polymer having at least one block made of an aromatic vinyl compound-conjugated diene compound random copolymer is 50% by weight or less, preferably 40% by weight or less, the polymer has rubber-like elastic characteristics. When the content is more than 50% by weight, preferably more than 60% by weight, the polymer has characteristics like those of a flexible soft resin. For the objects of the invention, a block copolymer comprising at least one polymer block B1 composed mainly of aromatic vinyl compound units (the content of aromatic vinyl compound units: at least 90% by weight) and at least one aromatic vinyl compound-conjugated diene compound random copolymer block B2 (the content of aromatic vinyl compound units: less than 90% by weight and not less than 3% by weight) is preferable. The content of aromatic vinyl compound units ranges from 50 to 90% by weight, preferably from 60 to 88% by weight, particularly preferably from 62 to 86% by weight. The content of aromatic vinyl compound units can be measured with an ultraviolet spectrophotometer, an infrared spectrophotometer, a nuclear magnetic resonance apparatus or the like. Specifically, the content was measured according to the measuring method described in International Publication No. WO 03/035705.

The microstructure, i.e., the polymerization style of the conjugated diene compound before hydrogenation in the polymer having at least one block made of any of the above-exemplified hydrogenated aromatic vinyl compound-conjugated diene compound random copolymers may be properly chosen. For example, in the case of 1,3-butadiene, the amount of 1,2-vinyl linkage is 2 to 85%, preferably 8 to 85%, more preferably 10 to 85%. In the case of isoprene, the total amount of 1,2-vinyl linkage and 3,4-vinyl linkage is 2 to 85%, preferably 3 to 75%, more preferably 3 to 60%.

The weight average molecular weight (the molecular weight in terms of polystyrene measured by gel permeation chromatography) of the polymer having at least one block made of any of the above-exemplified hydrogenated aromatic vinyl compound-conjugated diene compound random copolymers ranges from 100,000 to 1,000,000, preferably from 100,000 to 500,000, more preferably from 13,000 to 400,000, particularly preferably from 150,000 to 300,000. When the molecular weight is more than 100,000, the blocking resistance, loss factor and frictional wear properties are good. When the molecular weight is 1,000,000 or less, the molding processability is good. In addition, the ratio of the weight average molecular weight to the number average molecular weight (Mw/Mn) is preferably 1.5 to 5.0, more preferably 1.6 to 4.5, particularly preferably 1.8 to 4.0, from the viewpoint of molding processability.

As to the hydrogenation rate of the component (B) in the resin composition of the invention, 85% or more of double bonds due to the conjugated diene compound are preferably hydrogenated from the viewpoint of blocking resistance, frictional wear properties and heat aging characteristics. This percentage is preferably 90% or more, more preferably 92% or more, particularly preferably 95% or more.

The above-mentioned polymer having at least one block made of an aromatic vinyl compound-conjugated diene compound random copolymer, which comprises a conjugated diene compound polymer before hydrogenation, is obtained by anionic polymerization of the conjugated diene compound and the aromatic vinyl compound in a hydrocarbon solvent by using an organolithium compound as a polymerization initiator. As the hydrocarbon solvent, aliphatic, alicyclic and aromatic hydrocarbons can be used. The hydrocarbon solvent includes, for example, propane, isobutane, n-hexane, isooctane, cyclopentane, cyclohexane, benzene and toluene. Especially preferable solvents are n-hexane, cyclohexane and benzene. The above-exemplified solvents may be used alone or as a mixed solvent of two or more of them. As the organolithium compound as polymerization initiator used in the polymerization, there can be used mono-organolithium compounds such as n-propyllithium, isopropyllithium, n-butyllithium, sec-butyllithium, tert-butyllithium, etc.; and polyfunctional organolithium compounds such as dilithiomethane, 1,4-dilithiobutane, 1,4-dilithio-2-ethylcyclohexane, 1,2-dilithio-1,2-diphenylmethane, 1,3,5-trilithiobenzene, etc. These may be used alone or as a mixture thereof. The amount of the organolithium compound used may be properly chosen depending on the number average molecular weight of the desired polymer containing conjugated diene compound units, by calculation on the assumption that the polymer is a monodisperse polymer (weight average molecular weight/number average molecular weight=1).

Usually, polar compounds such as ethers, tertiary amines, alkali metal alkoxides and the like can be used for adjusting the increase of the amounts of 1,2-vinyl bond and 3,4-vinyl bond in the above-mentioned microstructure as the polymerization style of the conjugated diene compound or adjusting the randomness in the aromatic vinyl compound-conjugated diene compound copolymer chain. The polar compounds include, for example, diethyl ether, ethylene glycol•dimethyl ether, ethylene glycol•di-n-butyl ether, ethylene glycol•n-butyl-tert-butyl ether, ethylene glycol•di-tert-butyl ether, diethylene glycol•dimethyl ether, triethylene glycol•dimethyl ether, tetrahydrofuran, α-methoxymethyltetrahydrofuran, dioxane, 1,2-dimethoxybenzene, triethylamine, N,N,N′,N′-tetramethylethylenediamine, potassium-tert-amyl oxide and potassium-tert-butyl oxide. These compounds may be used alone or as a mixture thereof. The amount of the polar compound used is 0 mole or more, preferably 0 to 300 moles, per mole of the organolithium compound.

In the invention, a method for copolymerizing the conjugated diene compound with the aromatic vinyl compound by the use of the organolithium compound as polymerization initiator may be batch polymerization, continuous polymerization or a combination thereof. In particular, the continuous polymerization is recommended for adjusting the molecular weight distribution so that the distribution may preferably fall within a suitable range. The polymerization temperature is generally 0 to 180° C., preferably 30 to 150° C. Although the time required for the polymerization varies depending on conditions, it is usually 48 hours or less. It is particularly preferably 0.1 to 10 hours. The atmosphere in the polymerization system is preferably an inert gas atmosphere of nitrogen gas or the like. The polymerization pressure is not particularly limited and the polymerization may be carried out at a sufficient pressure to keep the monomers and a solvent liquid in the above-mentioned polymerization temperature range.

In addition, care should be taken to prevent the contamination of the polymerization system with impurities capable of inactivating a catalyst and a living polymer, such as water, oxygen, carbon dioxide gas and the like.

Furthermore, coupling reaction can be carried out by adding a necessary amount of a bifunctional or higher-order polyfunctional coupling agent at the conclusion of the above-mentioned polymerization. It is also possible to use a modified copolymer formed by bonding of an atomic group containing a polar group(s) to at least one polymer chain of a polymer. As the polar atomic group, there can be exemplified atomic groups containing at least one polar group selected from the group consisting of, for example, hydroxyl group, carboxyl group, carbonyl group, thiocarbonyl group, acid halide groups, acid anhydride groups, carboxylic acid groups, thiocarboxylic acid groups, aldehyde group, thioaldehyde group, carboxylic ester groups, amide group, sulfonic ester groups, phosphoric acid group, phosphoric ester groups, amino group, imino group, nitrile group, pyridyl group, quinoline group, epoxy group, thioepoxy group, sulfide group, isocyanate group, thioisocyanate group, silicon halide groups, silanol group and alkoxysilicon groups. The modified copolymer is obtained by reacting a compound having such an atomic group containing a polar group(s), at the conclusion of polymerization for the production of copolymer. A preferable modified hydrogenated copolymer in the invention is a modified hydrogenated copolymer having, as an atomic group(s) bonded thereto, an atomic group(s) having at least one functional group selected from the group consisting of hydroxyl group, epoxy group, amino group, acid anhydride groups, carboxylic acid groups, amide group, silanol group and alkoxysilane groups.

The polymer having at least one block made of a hydrogenated aromatic vinyl compound-conjugated diene compound random copolymer can be obtained by hydrogenating a polymer having at least one block made of a non-hydrogenated aromatic vinyl compound-conjugated diene compound random copolymer (including modified copolymers obtained by modification with the above-exemplified functional group(s)) in a hydrocarbon solvent by the addition of a hydrogenation catalyst and hydrogen gas to reduce the amount of olefinic unsaturated bonds due to the conjugated diene compound which are present in the polymer, to 90% or less, preferably 55% or less, more preferably 20% or less. Regarding such hydrogenation, a process for producing the desired polymer is not limited and may be any production process so long as it permits reduction of the amount of olefinic unsaturated bonds due to the conjugated diene compound which is present in the polymer having at least one block made of an aromatic vinyl compound-conjugated diene compound random copolymer. There are used, for example, supported heterogeneous hydrogenation catalysts obtained by supporting a metal (e.g. Ni, Pt, Pd or Ru) on carbon, silica, alumina, diatomaceous earth or the like; so-called Ziegler hydrogenation catalysts using a transition metal salt such as an organic acid salt or acetylacetone salt of Ni, Co, Fe, Cr or the like and a reducing agent such as organoaluminum or the like; and homogeneous hydrogenation catalysts such as so-called organometallic complexes of Ti, Ru, Rh, Zr and the like. As to specific examples of the hydrogenation catalysts, there can be used the catalysts described in JP-B-42-8704, JP-B-43-6636, JP-A-60-220147, JP-A-61-33132, JP-A-62-207303, Brit. Patent No. 1020720, U.S. Pat. Nos. 3333024 and 4501857. Preferable examples of the hydrogenation catalyst are titanocene compounds, reducing organometallic compounds, and mixtures thereof. As the titanocene compounds, the compounds described in JP-A-8-109219 can be used. Specific examples of the titanocene compound are compounds having at least one ligand having a (substituted) cyclopentadienyl skeleton, indenyl skeleton or a fluorenyl skeleton, such as bis(cyclopentadienyl)titanium dichloride, monopentamethylcyclopentadienyltitanium trichloride and the like. The reducing organometallic compounds include organic alkali metal compounds (e.g. organolithium compounds), organomagnesium compounds, organoaluminum compounds, organoboron compounds, organozinc compounds and the like.

In the invention, the following are recommended: the hydrogenation temperature is generally 0 to 200° C., preferably 30 to 150° C., and the pressure of hydrogen used in the hydrogenation is 0.1 to 15 MPa, preferably 0.2 to 10 MPa, more preferably 0.3 to 5 MPa. The hydrogenation time is 3 minutes to 10 hours, preferably 10 minutes to 5 hours. The hydrogenation can be carried out by a batch process, a continuous process or a combination thereof. The hydrogenation rate of the hydrogenated polymer obtained by any of these processes can easily be known by infrared spectroscopy, nuclear magnetic resonance analysis or the like.

Such a polymer having at least one block made of a hydrogenated aromatic vinyl compound-conjugated diene compound random copolymer should have the main dispersion peak of tan δ at 60° C. or below in the viscoelastic spectrum. When the main dispersion peak of tan δ in the viscoelastic spectrum is at 60° C. or below, the vibration-damping and sound-damping capability near ordinary temperature (23° C.) is good. In addition, the main dispersion peak of tan δ is preferably at a temperature in the range of 60 to −30° C., more preferably 60 to −20° C., particularly preferably 50 to −10° C., in view of well balanced vibration-damping and sound-damping capability depending on temperatures. Measurement of tan δ was carried out in a torsional mode (measuring frequency: 1 Hz) by the use of ARES Dynamic Analyzer (Rheometrics•Scientific•F•E Co., Ltd., Japan).

As the polymer having at least one block made of a hydrogenated aromatic vinyl compound-conjugated diene compound random copolymer which is used in the invention, that modified by grafting with an α,β-unsaturated carboxylic acid or its derivative such as its anhydride, ester compound, amide compound or imide compound can also be used. Specific examples of the α,β-unsaturated carboxylic acid or derivative thereof are maleic anhydride, maleic anhydride imide, acrylic acid or its ester, methacrylic acid or its ester, and endo-cis-bicyclo[2,2,1]-5-heptene-2,3-dicarboxylic acid or its anhydride. The amount of the α,β-unsaturated carboxylic acid or derivative thereof added is 0.01 to 5 parts by weight, preferably 0.1 to 2 parts by weight, per 100 parts by weight of the polymer having at least one block made of a hydrogenated aromatic vinyl compound-conjugated diene compound random copolymer.

In addition, the polymer having at least one block made of a hydrogenated aromatic vinyl compound-conjugated diene compound random copolymer can be used after being previously converted to a crosslinked product obtained by the use of an organic peroxide or the like. It is also possible to use mineral oils (naphthene type and/or paraffin type) as a softener for rubber.

As the olefin resin used as the component (C) in the resin composition of the invention, there can be exemplified homopolymers and copolymers of compounds such as ethylene, propylene, butene, pentene, methylpentene, hexene, heptene, octene, nonene, decene, undecene, dodecene, butadiene, isoprene, norbornene and the like; hydrogenated products thereof; and copolymers of the above-exemplified compounds with other copolymerizable compounds. Specific examples of the olefin resin are polyethylenes (high-density polyethylenes, medium-density polyethylenes, low-density polyethylenes, linear low-density polyethylenes and ultra-low-density polyethylenes), polypropylenes, ethylene-propylene copolymers, ethylene-butene copolymers, ethylene-octene copolymers, propyrene-butene copolymers, polybutenes, hydrogenated polybutadienes, hydrogenated polyisoprenes, ethylene-vinyl acetate copolymers, ethylene-ethyl acrylate copolymers, ethylene-methyl methacrylate copolymers and ethylene-vinyl alcohol copolymers. As the olefin resin, there can also be exemplified acid-modified olefin resins obtained by modifying the above-exemplified olefin resins with an α,β-unsaturated carboxylic acid (e.g. acrylic acid, methacrylic acid, maleic acid, fumaric acid, itaconic acid, citraconic acid or nadic acid) and/or an acid anhydride thereof (if necessary, a peroxide is used in combination with them). Copolymers of any of the above-exemplified olefin compounds and an acid anhydride may also be used. It is also possible to use a combination of two or more of the above-exemplified unmodified olefin resins and acid-modified olefin resins.

As the component (C) used in the resin composition of the invention, the acid-modified olefin resins are preferably used from the viewpoint of impact resistance and peeling although the mechanism of their action has not yet been elucidated. When the acid-modified olefin resins are used, the acid modification rate (the weight proportion of the acid used for the modification to the olefin resin) ranges preferably from 3 to 0.01% by weight, more preferably from 2 to 0.05% by weight, particularly preferably from 1 to 0.1% by weight. When the acid modification rate is more than 3% by weight, the thermal stability is undesirably deteriorated. When the acid modification rate is more than 0.01% by weight, improving effect is brought about. The acid modification rate of the acid-modified olefin resin can be determined by dissolving a resin sample in hot xylene, followed by titration with sodium methylate by the use of phenolphthalein as an indicator.

As to the proportions of the components (A), (B) and (C) of the resin composition of the invention (in the case where the total proportion of the components (A), (B) and (C) is taken as 100 parts by weight), the proportion of the component (A) is 10 to 99.5 parts by weight and the total proportion of the components (B) and (C) is 90 to 0.5 parts by weight. Preferably, the proportion of the component (A) is 15 to 99.0 parts by weight and the total proportion of the components (B) and (C) is 85 to 1.0 part by weight. More preferably, the proportion of the component (A) is 20 to 98.0 parts by weight and the total proportion of the components (B) and (C) is 80 to 2.0 parts by weight. The weight ratio of the component (B) to the component (C) should be in the range of 100/0 to 20/80, preferably 100/0 to 30/70, more preferably 100/0 to 40/60. When the weight percentage of the component (B) is more than 20% by weight based on the total weight of the components (B) and (C), a satisfactory sound-damping and vibration-damping effect can be obtained.

As to the dispersed states of the components (A), (B) and (C) of the resin composition of the invention, there are a case where the component (A) is present as a continuous phase and the components (B) and (C) are present as a dispersed phase; a case where the components (B) and (C) are present as a continuous phase and the component (A) is present as a dispersed phase, and a stage intermediate between them. Any of these cases may be employed.

The silicone-grafted polyolefin resin used as the component (D) in the resin composition of the invention is a mixture of silicone gum and a resin obtained by the graft reaction of silicone gum with a polyolefin resin.

The silicone gum is a compound represented by the following formula (3): 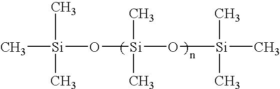
wherein each methyl group may be substituted by a substituent having hydrogen, an alkyl group, a phenyl group, an ether group, an ester group or a reactive substituent such as hydroxyl group, amino group, epoxy group, carboxyl group, carbinol group, methacryl group, mercapto group, phenol group, vinyl group, allyl group, polyether group, fluorine-containing alkyl group or the like; and n indicates an average polymerization degree and ranges from 1,000 to 10,000, and an n value in the range of less than 1,000 or more than 10,000 is not desirable because the sliding capability is insufficient.

The resin obtained by the graft reaction of silicone gum with a polyolefin resin is a resin obtained by graft-polymerizing a compound represented by a poly(dimethylsiloxane) of the following formula (3) onto a polyolefin resin such as a low-density polyethylene, linear low-density polyethylene, high-density polyethylene, ethylene-vinyl acetate copolymer, ethylene-methyl methacrylate copolymer, ethylene-ethyl acrylate copolymer, polymethylpentene, polypropylene or tetrafluoroethylene-ethylene copolymer (if necessary, these resins may contain a small amount of a vinyl monomer such as vinyl acetate): 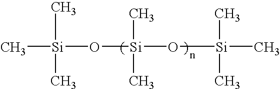
wherein each methyl group may be substituted by a substituent having hydrogen, an alkyl group, a phenyl group, an ether group, an ester group or a reactive substituent such as hydroxyl group, amino group, epoxy group, carboxyl group, carbinol group, methacryl group, mercapto group, phenol group, vinyl group, allyl group, polyether group, fluorine-containing alkyl group or the like, and preferably has a substituent having a vinyl group or an allyl group, preferably a vinyl group, for grafting; and the average polymerization degree n ranges from 1,000 to 10,000 and a n value in the range of less than 1,000 or more than 10,000 is not desirable because the sliding capability is insufficient.

The resin obtained by grafting the silicone gum onto the polyolefin can be produced by melt-kneading the above-mentioned polyolefin resin and silicone gum at a specific temperature under specific shearing conditions, as described in JP-B-52-36898 (corresponding to U.S. Pat. No. 3,865,897).

The same technique as above is described in detail in JP-B-56-1201 (corresponding to U.S. Pat. No. 4,252,915) and JP-A-1-230652. When the polyolefin resin and the silicone gum are melt-kneaded, a very small amount of an organic peroxide may be used so long as the graft rate is within the range described hereinafter.

In the resin obtained by the graft reaction of the silicone gum with the polyolefin resin which is used in the resin composition of the invention, the silicone gum should be loosely grafted onto the polyolefin resin (to such an extent that the silicone component has no high-degree crosslinked structure capable of giving rubber elasticity and that the sliding-capability-improving effect of the silicone component is not lessened). As an indication of this grafting, there is employed the graft rate of the silicone gum (a value (% by weight) obtained by dividing a value obtained by subtraction of the amount of the silicone released by dissolution from the amount of the silicone added, by the amount of the silicone added) determined by a release-by-dissolution test using a solvent (e.g. a halogenated hydrocarbon such as trichloroethylene or chloroform, or an aromatic hydrocarbon such as toluene or xylene). This graft rate should be in the range of 95 to 30% by weight, preferably 90 to 40% by weight, more preferably 90 to 50% by weight.

When the graft rate is less than 30% by weight, the amount of free silicone gum is increased, resulting in the deterioration of peeling of a thin molded article and the deterioration of the sliding properties after contact with a solvent, which is undesirable. When the graft rate is more than 95% by weight, crosslinking of the silicone gum proceeds, so that the sliding properties are undesirably deteriorated.

The ratio of the polyolefin resin to the silicone gum in the resin obtained by the graft reaction of the silicone gum with the polyolefin resin ranges from 80/20 to 20/80 by weight, preferably from 70/30 to 30/70 by weight. When the proportion of the polyolefin is more than 80% by weight, the improving effect on the sliding properties is undesirably insufficient. When the proportion of the silicone gum is more than 80% by weight, not only the production of the desired resin but also the maintenance of the graft rate is undesirably difficult.

As the silicone compound used as starting material, that having as low content of cyclic low-molecular weight monomers and oligomers as possible is preferable from the viewpoint of staining of an electrical contact.

Such resins obtained by the graft reaction of the silicone gum with the polyolefin resin are placed on the market as silicone master pellets by Dow Corning Asia Ltd. Specifically, grades such as SP-100, SP-110, SP-300, SP-310 and SP-350 can be exemplified.

When such a silicone compound is used, its proportion is 0.1 to 30 parts by weight, preferably 0.3 to 20 parts by weight, more preferably 0.3 to 10 parts by weight, per 100 parts by weight of the sum of the resin components (A), (B) and (C). When the amount of the silicone compound added is less than 0.1 part by weight, only insufficient improving effect on the sliding properties can be obtained. When the silicone compound is added in an amount of more than 30 parts by weight, the depth of wear is increased and peeling of a molded article is deteriorated. This is undesirable.

The lubricant used as the component (E) in the resin composition of the invention is at least one member selected from the group consisting of alcohols, fatty acids, esters of an alcohol and a fatty acid, esters of an alcohol and a dicarboxylic acid, polyoxyalkylene glycols and olefin compounds having an average polymerization degree of 10 to 500.

The alcohols used include monohydric alcohols and polyhydric alcohols. As the monohydric alcohol, there can be exemplified saturated or unsaturated alcohols such as octyl alcohol, nonyl alcohol, decyl alcohol, undecyl alcohol, lauryl alcohol, tridecyl alcohol, myristyl alcohol, pentadecyl alcohol, cetyl alcohol, heptadecyl alcohol, stearyl alcohol, oleyl alcohol, nonadecyl alcohol, eicosyl alcohol, ceryl alcohol, behenyl alcohol, melissyl alcohol, hexyldecyl alcohol, octyldodecyl alcohol, decylmyristyl alcohol, decylstearyl alcohol, unilin alcohol, etc.

As the polyhydric alcohols, there can be exemplified ethylene glycol, diethylene glycol, triethylene glycol, propylene glycol, dipropylene glycol, butanediol, pentanediol, hexanediol, glycerol, diglycerol, triglycerol, threitol, erythritol, pentaerythritol, arabitol, ribitol, xylitol, sorbite, sorbitan, sorbitol and mannitol.

As the fatty acids, there can be exemplified caproic acid, enanthic acid, caprylic acid, pelargonic acid, capric acid, undecylic acid, lauric acid, tridecylic acid, myristic acid, pentadecylic acid, palmitic acid, stearic acid, nanodecanoic acid, arachic acid, behenic acid, lignoceric acid, cerotic acid, heptacosanoic acid, montanic acid, melissic acid, lacceric acid, undecylenic acid, oleic acid, elaidic acid, cetoleic acid, erucic acid, brassidic acid, sorbic acid, linoleic acid, linolenic acid, arachidonic acid, propiolic acid and stearolic acid. There can also be exemplified fatty acids comprising these components and existing in nature, and mixtures thereof.

The above-exemplified fatty acids may be substituted by a hydroxyl group(s). There can also be used synthetic fatty acids obtained by carboxyl modification of the end of unilin alcohol, a synthetic aliphatic alcohol.

The esters of an alcohol and a fatty acid are esters of any of the following alcohols and any of the esters exemplified below. The alcohols used in such esters are monohydric alcohols and polyhydric alcohols. As the monohydric alcohols, there can be exemplified saturated or unsaturated alcohols such as methyl alcohol, ethyl alcohol, propyl alcohol, butyl alcohol, amyl alcohol, hexyl alcohol, heptyl alcohol, octyl alcohol, nonyl alcohol, decyl alcohol, undecyl alcohol, lauryl alcohol, tridecyl alcohol, myristyl alcohol, pentadecyl alcohol, cetyl alcohol, heptadecyl alcohol, stearyl alcohol, oleyl alcohol, nonadecyl alcohol, eicosyl alcohol, ceryl alcohol, behenyl alcohol, melissyl alcohol, hexyldecyl alcohol, octyldodecyl alcohol, decylmyristyl alcohol, decylstearyl alcohol, unilin alcohol, etc.

The polyhydric alcohols used in the esters are polyhydric alcohols containing 2 to 6 carbon atoms, and include, for example, ethylene glycol, diethylene glycol, triethylene glycol, propylene glycol, dipropylene glycol, butanediol, pentanediol, hexanediol, glycerol, diglycerol, triglycerol, pentaerythritol, arabitol, ribitol, xylitol, sorbite, sorbitan, sorbitol and mannitol.

As the fatty acids used in the ester, there can be exemplified caproic acid, enanthic acid, caprylic acid, pelargonic acid, capric acid, undecylic acid, lauric acid, tridecylic acid, myristic acid, pentadecylic acid, palmitic acid, stearic acid, nanodecanoic acid, arachic acid, behenic acid, lignoceric acid, cerotic acid, heptaconic acid, montanic acid, melissic acid, laxelic acid, undecylenic acid, oleic acid, elaidic acid, cetoleic acid, erucic acid, brassidic acid, sorbic acid, linoleic acid, linolenic acid, arachidonic acid, propiolic acid and stearolic acid. There can also be exemplified fatty acids comprising these components and existing in nature, and mixtures thereof.

In addition, the above-exemplified fatty acids may be substituted by a hydroxyl group(s). There can also be used synthetic fatty acids obtained by carboxyl modification of the end of unilin alcohol, a synthetic aliphatic alcohol. Of the above-exemplified alcohols, fatty acids and esters of an alcohol and a fatty acid, esters of a fatty acid of 12 or more carbon atoms and an alcohol are preferable, esters of a fatty acid of 12 or more carbon atoms and an alcohol of 10 or more carbon atoms are more preferable, and esters of a fatty acid of 12 to 30 carbon atoms and an alcohol of 10 to 30 carbon atoms are still more preferable.

The esters of an alcohol and a dicarboxylic acid are monoesters and diesters of the following alcohols and dicarboxylic acids, and mixtures thereof: saturated or unsaturated primary alcohols such as octyl alcohol, nonyl alcohol, decyl alcohol, undecyl alcohol, lauryl alcohol, tridecyl alcohol, myristyl alcohol, pentadecyl alcohol, cetyl alcohol, heptadecyl alcohol, stearyl alcohol, oleyl alcohol, nonadecyl alcohol, eicosyl alcohol, ceryl alcohol, behenyl alcohol, melissyl alcohol, hexyldecyl alcohol, octyldodecyl alcohol, decylmyristyl alcohol, decylstearyl alcohol, unilin alcohol, etc.; and dicarboxylic acids such as oxalic acid, malonic acid, succinic acid, glutaric acid, adipic acid, pimelic acid, suberic acid, azelaic acid, sebacic acid, undecanoic acid, brassylic acid, maleic acid, fumaric acid, glutaconic acid, etc. Of these esters of an alcohol and a dicarboxylic acid, esters of an alcohol of 10 or more carbon atoms and a dicarboxylic acid are preferable.

As the polyoxyalkylene glycol compounds, three kinds of compounds can be exemplified. As polyoxyalkylene glycol compounds of a first group, polycondensation products obtained by using alkylene glycols as monomers can be exemplified. They include, for example, polyethylene glycols, polypropylene glycols, and block polymers of ethylene glycol and propylene glycol. The number of moles of an alkylene glycol(s) polymerized in these compounds ranges preferably from 5 to 1,000, more preferably from 10 to 500.

Polyoxyalkylene glycol compounds of a second group are ether compounds obtained from any of the compounds of the first group and an aliphatic alcohol. They include, for example, polyethylene glycol oleyl ethers (the number of moles of ethylene oxide polymerized: 5 to 50), polyethylene glycol cetyl ethers (the number of moles of ethylene oxide polymerized: 5 to 50), polyethylene glycol stearyl ethers (the number of moles of ethylene oxide polymerized: 5 to 30), polyethylene glycol lauryl ethers (the number of moles of ethylene oxide polymerized: 5 to 30), polyethylene glycol tridecyl ethers (the number of moles of ethylene oxide polymerized: 5 to 30), polyethylene glycol nonylphenyl ethers (the number of moles of ethylene oxide polymerized: 2 to 100) and polyethylene glycol octylphenyl ethers (the number of moles of ethylene oxide polymerized: 4 to 50).

Polyoxyalkylene glycol compounds of a third group are ester compounds obtained from any of the compounds of the first group and a higher fatty acid. They include, for example, polyethylene glycol monolaurate (the number of moles of ethylene oxide polymerized: 2 to 30), polyethylene glycol monostearate (the number of moles of ethylene oxide polymerized: 2 to 50) and polyethylene glycol monooleate (the number of moles of ethylene oxide polymerized: 2 to 50).

The olefin compounds having an average polymerization degree of 10 to 500 are compounds represented by the following formula (4): 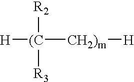
wherein each of R₂ and R₃, which may be the same or different, is selected from the group consisting of hydrogen, alkyl groups, aryl groups and ether groups; m indicates an average polymerization degree of 10 to 500; the alkyl groups are, for example, ethyl group, propyl group, butyl group, hexyl group, octyl group, decyl group, lauryl group, cetyl group and stearyl group; the aryl groups are, for example, phenyl group, p-butylphenyl group, p-octylphenyl group, p-nonylphenyl group, benzyl group, p-butylbenzyl group, tolyl group and xylyl group; and the ether groups are, for example, ethyl ether group, propyl ether group and butyl ether group.

Specific examples of monomer constituting the olefin compounds are olefin monomers such as ethylene, propylene, 1-butene, 2-butene, isobutylene, 1-pentene, 2-pentene, 4-methyl-pentene, 2-methyl-1-butene, 3-methyl-1-butene, 2-methyl-2-butene, 1-hexene, 2,3-dimethyl-2-butene, 1-heptene, 1-octene, 1-nonene, 1-decene, etc. There can also be exemplified diolefin monomers such as allene, 1,2-butadiene, 1,3-butadiene, 1,3-pentadiene, 1,4-pentadiene, 1,5-hexadiene, cyclopentadiene, etc. Compounds obtained by copolymerizing two or more of the above-exemplified olefin monomers and diolefin monomers may also be used. When the olefin compound is a compound obtained by polymerizing the diolefin monomer, the olefin compound is preferably such that the amount of its carbon-carbon unsaturated bonds has been reduced as much as possible by a conventional hydrogenation method in order to improve the thermal stability.

The average polymerization degree n of olefin units constituting the olefin compound should be in the range of 10 to 500, preferably 15 to 300, more preferably 15 to 100. When the average polymerization degree n is less than 10, the long-term sliding characteristics are deteriorated and an undesirable influence on the mold staining properties is exerted. This is undesirable. When n is more than 500, the initial sliding characteristics are noticeably deteriorated, which is undesirable.

When the lubricant is used, its proportion is preferably 0.05 to 20 parts by weight, more preferably 0.1 to 10 parts by weight, most preferably 0.1 to 5 parts by weight, per 100 parts by weight of the sum of the resin components (A), (B) and (C). Use of the above-mentioned silicone compound and lubricant in combination makes it possible to attain performance characteristics suitable for a material on which the resin composition slides.

As the inorganic filler used as the component (F) in the resin composition of the invention, fibrous, particulate, laminar or hollow fillers are used. As the fibrous fillers, there can be exemplified inorganic fibers such as glass fiber, asbestos fiber, carbon fiber, silica fiber, silica•alumina fiber, zirconia fiber, boron nitride fiber, silicon nitride fiber, boron fiber, potassium titanate fiber, and metal fibers of stainless steel, aluminum, titanium, copper, brass and the like. The fibrous fillers also include whiskers with a short fiber length of potassium titanate, zinc oxide, titanium oxide and the like, and needle-like wollastonite (calcium silicate).

The particulate fillers include graphite, carbon black, electroconductive carbon black, carbon nanotubes, silica, quartz powder, glass beads, glass powder, aluminum silicate, kaolin, talc, clay, diatomaceous earth, nepheline syenite, cristobalite, wollastonite (calcium silicate), iron oxide, zinc oxide, titanium oxide, alumina, calcium sulfate, barium sulfate, calcium carbonate, magnesium carbonate, dolomite, calcium phosphate, hydroxyapatite, silicon carbide, silicon nitride, boron nitride, various metal powders and the like. The laminar fillers include mica, glass flakes, various metal foils and the like.

The hollow fibers include glass tube, glass balloons, silica balloons, Shirasu balloons, metal balloons and the like. These fillers may be used alone or in combination.

As the above-exemplified fillers, either surface-treated ones or surface-untreated ones may be used. The surface-treated ones are preferably used in some cases from the viewpoint of the surface smoothness and mechanical properties of a molded article. Conventional surface-treating agents may be used. For example, various coupling treating agents such as silane type agents, titanate type agents, aluminum type agents, zirconium type agents, etc. may be used.

Specific examples of the surface-treating agents are N-(2-aminoethyl)-3-aminopropyltriethoxysilane, 3-glycidoxypropyltrimethoxysilane, isopropyltristearoyl titanate, diisopropoxyammonium ethylacetate and n-butyl zirconate.

Although the particle size of the above-exemplified fillers is not particularly specified because it depends on the purpose of use of each filler, it is classified as follows according to the purpose of use.

(1) Impartment of the Surface Appearance of a Molded Article and Sliding Properties

As to the particle size of the inorganic filler used, its volume average particle size is 100 μm or less, preferably 50 μm or less, more preferably 30 μm or less, for imparting the surface appearance of a molded article and excellent sliding properties. Specific examples of inorganic filler preferably used for this purpose are potassium titanate whisker, wollastonite (needle-like or particulate), calcium carbonate, talc, graphite, nepheline syenite, hydroxyapatite, silica, carbon black and kaolin. Potassium titanate whisker, wollastonite (needle-like or particulate), calcium carbonate, talc and carbon black are especially preferable.

(2) Impartment of Stiffness

For imparting a high stiffness to a molded article, glass fiber, glass flakes, carbon fiber, mica and the like are used.

(3) Impartment of Electroconductivity For imparting electroconductivity to a molded article, carbon black, electroconductive carbon black, carbon nanotubes, carbon fiber and the like are used.

When any of the above-exemplified fillers is used, the proportion of the filler added is widely varied depending on its purpose. The filler is used in a proportion of approximately 0.1 to 150 parts by weight, preferably 0.5 to 100 parts by weight, per 100 parts by weight of the sum of the resin components (A), (B) and (C). When the proportion is less than 0.5 part by weight, the reinforcing effect of the filler is insufficient. When the proportion is more than 150 parts by weight, not only the surface appearance but also the molding processability and the impact resistance are undesirably deteriorated.

Furthermore, in the polyoxymethylene resin composition of the invention, various additives (e.g. lubricants, impact resistance improving materials, other resins, nucleating agents, mold release agents, dyes, pigments and the like, which are other than those described in the present specification) used in the case of conventional polyoxymethylene resins may be used if desired, so long as the objects of the invention are not affected.

In a process for producing the resin composition of the invention, a conventional melt-kneading machine can be used. The melt-kneading machine includes kneaders, roll mills, single-screw extruders, twin-screw extruders, multiple-screw extruders and the like. In this case, the processing temperature is preferably 180 to 240° C. Replacement with an inert gas and deaeration using a single-stage vent and a multistage vent are preferable for maintaining the quality and work environment.

The molded article of the invention is produced by a molding or shaping method such as injection molding, hot-runner injection molding, outsert molding, insert molding, gas-assist injection blow molding, injection molding using a mold subjected to high-frequency heating, compression molding, blown-film extrusion, blow-forming, extrusion, cutting of an extruded product, or the like.

Such a molded article is used as working parts represented by latches, stoppers, gears, cams, sliders, levers, arms, clutches, felt clutches, idler gears, pulleys, rollers, key stems, key tops, shutters, reels, shafts, joints, bearings, guides and the like; parts produced by outsert or insert molding for a substrate or part of a metal or resin; connectors; the caps of terminals; and the like, by taking advantage of its characteristics such as flexibility, vibration-damping and sound-damping capability, frictional wear properties under a heavy load and oil resistance. The molded article is especially useful as latches, stoppers and sound-damping gears when its flexibility, vibration-damping and sound-damping capability, and frictional wear properties under a heavy load are utilized. The molded article is useful also as connectors and the caps of terminals because of its excellent hinge capability.

Specific examples of preferable use for the above-mentioned molded article are the following uses (1) to (3).

(1) Parts for electric and electronic equipments, such as parts for office automation appliances represented by printers and copying machines; parts for cameras or video appliances represented by VTR (video tape recorder), video movies, digital video cameras, cameras and digital cameras; parts for music, image or information appliances represented by cassette players, DAT, LD (laser disk), MD (mini disk), CD (compact disk) [including CD-ROM (read only memory), CD-R (recordable) and CD-RW (rewritable)], DVD (digital versatile disk) [including DVD-ROM, DVD-R, DVD-RW, DVD-RAM (random access memory) and DVD-Audio], optical disk drives, HDD, MFD, MO, navigation systems and mobile personal computers; and parts for communication appliances represented by mobile phones and facsimile telegraphs.

(2) Parts for automobile, such as parts for doors represented by a door lock, door handle, window regulator, speaker grille and the like; parts around seat belts such as a slip ring, press button, through anchor, tongue and the like; parts for combination switches; and parts for switches and clips.

(3) Industrial parts represented by the nib of a propelling pencil and working parts for putting in and out the lead of the propelling pencil; a washstand, its drainage hole, and working parts for opening and shutting a drainage tap; parts for the openable-and-closable-portion locking mechanism and commodity-discharging mechanism of an automatic vending machine; cord stoppers, adjusters and buttons for clothing; nozzles for water sprinkling, and joints for connecting a water-sprinkling hose; building components as a handrail for stairs and a bearer for flooring; disposable cameras; toys; fasteners; chains; conveyers; buckles; sports goods; automatic vending machines; furniture; musical instruments; and house equipment appliances.

The invention is specifically illustrated with the following examples. At first, the details of the components used in the examples and comparative examples and evaluation methods are described below.

[Details of the components used]

A. Polyoxymethylene Resins

a-1; A jacketed twin-screw paddle type continuous polymerizer through which a heating medium could be passed was adjusted to 80° C., followed by feeding thereto trioxane (the content of water and formic acid: 4ppm) at a rate of 40 moles/hr and at the same time, 1,3-dioxolane as cyclic formal at a rate of 2 moles/hr. Polymerization was carried out by continuously feeding boron trifluoride di-n-butyl etherate as polymerization catalyst in the form of a solution in cyclohexane in an amount of 5x 10⁻⁵ mole per mole of trioxane and a hydrogenated polybutadiene (Mn=2330) with a hydroxyl group at each end of the following formula (7) as chain transfer agent in an amount of 1x 10⁻³ mole per mole of trioxane. The polymer discharged from the polymerizer was added to a 1% aqueous triethylamine solution to inactivate the polymerization catalyst completely. Then, the polymer was washed by filtration and triethyl(2-hydroxyethyl)ammonium formate was added as quaternary ammonium compound in an amount of 20 ppm by weight in terms of nitrogen per part by weight of the crude polyoxymethylene copolymer washed by the filtration. They were uniformly mixed and the resulting mixture was dried at 120° C.

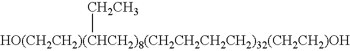

Subsequently, 0.3 part by weight of triethylene glycol-bis[3-(3-t-butyl-5-methyl-4-hydroxyphenyl) propionate] as antioxidant and 0.02 part by weight of calcium stearate were added to 100 parts by weight of the above-mentioned dried crude polyoxymethylene copolymer, and the resulting mixture was fed to a vent-type twin-screw extruder. Water and/or triethylamine were added to the molten polyoxymethylene copolymer in the extruder according to need, and the unstable terminal portions of this copolymer were decomposed at a preset temperature of the extruder of 200° C. for a residence time in the extruder of 5 minutes. The polyoxymethylene copolymer subjected to the decomposition of the unstable terminal portions was deaerated at a degree of vacuum for vent of 20 Torr, extruded as a strand through the die of the extruder, and then pelletized. The polyoxymethylene block copolymer thus obtained had a flexural modulus of 2,550 MPa and a melt flow rate of 9.3 g/10 min (ASTM D-1238-57T).

a-2; A jacketed twin-screw paddle type continuous polymerizer through which a heating medium could be passed was adjusted to 80° C., followed by feeding thereto trioxane (the content of water and formic acid: 4 ppm) at a rate of 40 moles/hr and at the same time, 1,3-dioxolane as cyclic formal at a rate of 2 moles/hr. Polymerization was carried out by continuously feeding boron trifluoride di-n-butyl etherate as polymerization catalyst in the form of a solution in cyclohexane in an amount of 5×10⁻⁵ mole per mole of trioxane and methylal [(CH₃O)₂CH₂] as chain transfer agent in an amount of 2×10⁻³ mole per mole of trioxane. The polymer discharged from the polymerizer was added to a 1% aqueous triethylamine solution to inactivate the polymerization catalyst completely. Then, the polymer was washed by filtration and triethyl(2-hydroxyethyl)ammonium formate was added as quaternary ammonium compound in an amount of 20 ppm by weight in terms of nitrogen per part by weight of the crude polyoxymethylene copolymer washed by the filtration. They were uniformly mixed and the resulting mixture was dried at 120° C.

Subsequently, 0.3 part by weight of triethylene glycol-bis[3-(3-t-butyl-5-methyl-4-hydroxyphenyl) propionate] as antioxidant and 0.02 part by weight of calcium stearate were added to 100 parts by weight of the above-mentioned dried crude polyoxymethylene copolymer, and the resulting mixture was fed to a vent-type twin-screw extruder. Water and/or triethylamine were added to the molten polyoxymethylene copolymer in the extruder according to need, and the unstable terminal portions of this copolymer were decomposed at a preset temperature of the extruder of 200° C. for a residence time in the extruder of 5 minutes. The polyoxymethylene copolymer subjected to the decomposition of the unstable terminal portions was deaerated at a degree of vacuum for vent of 20 Torr, extruded as a strand through the die of the extruder, and then pelletized. The polyoxymethylene copolymer thus obtained had a flexural modulus of 2,600 MPa and a melt flow rate of 9.0 g/10 min (ASTM D-1238-57T).

B. Polymer Having at Least One Aromatic Vinyl Compound-Conjugated Diene Compound Random Copolymer block

b-1: A styrene-butadiene random copolymer having the B1-B2-B1 structure was produced in cyclohexane solvent by the use of n-butyllithium as polymerization initiator in a stirrer-equipped reactor the inner atmosphere of which had been replaced with nitrogen gas. Thereafter, the polymeric liquid was transferred to another reactor the inner atmosphere of which had been replaced with nitrogen gas, and the ethylenic unsaturated groups of the polybutadiene portion were hydrogenated under hydrogen pressure by the use of a hydrogenation catalyst. The hydrogenated polymer thus obtained had an amount of styrene bonded of 70% by weight, a content of all block styrene units in the polymer of 5% by weight, an amount of 1,2-vinyl linkage in the butadiene portion of 14% by weight, a weight average molecular weight of 190,000 as measured by GPC and a Mw/Mn value of 1.9. The tan δ peak temperature of this polymer was 15° C.

b-2: A styrene-butadiene random copolymer having the B1-B2-B1 structure was produced in cyclohexane solvent by the use of n-butyllithium as polymerization initiator in a stirrer-equipped reactor the inner atmosphere of which had been replaced with nitrogen gas. Thereafter, the polymeric liquid was transferred to another reactor the inner atmosphere of which had been replaced with nitrogen gas, and the ethylenic unsaturated groups of the polybutadiene portion were hydrogenated under hydrogen pressure by the use of a hydrogenation catalyst. The hydrogenated polymer thus obtained had an amount of styrene bonded of 68% by weight, a content of all block styrene units in the polymer of 13% by weight, an amount of 1,2-vinyl linkage in the butadiene portion of 14% by weight, a weight average molecular weight of 180,000 as measured by GPC and a Mw/Mn value of 1.8. The tan δ peak temperature of this polymer was 5° C.

b-3: A styrene-isoprene-styrene block copolymer (hybrar 5127, a trade name, mfd. by KURARAY Co., Ltd.; tan δ peak temperature 10° C.).

(C) Olefin Resin

c-1: A maleic anhydride-modified ethylene-butene copolymer (tafmer MH7010, a trade name, mfd. by Mitsui Chemicals Inc.; maleic acid modification rate 0.5% by weight).

c-2: An ethylene-butene copolymer (Toughmer A4090, a trade name, mfd. by Mitsui Chemicals Inc.).

(D) Silicone-Grafted Polyolefin Resin

d-1: A resin obtained by grafting a silicone compound onto a polyolefin by melt-kneading 24 g of an ethylene-methyl methacrylate copolymer having a methyl methacrylate unit content of 5% by weight and a melt index MI (ASTM-D 1238-57T) of 5 g/10 min and 36 g of the silicone compound of the following formula (8) for 20 minutes at a temperature of 180° C. and a number of revolution of 60 rpm by the use of Laboplastmill (mfd. by Toyo Seiki Seisaku-sho, Ltd.).

In this silicone-grafted polyolefin resin, the graft rate of the silicone compound was 70% by weight and the amount of free silicone compound was 18% by weight. 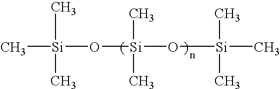
wherein the methyl groups are substituted by dimethylvinyl groups in an amount of 5 moles per 100 moles of the silicone compound, and n is about 5,000).
(E) Lubricant

e-1: A polyethylene glycol (molecular weight: 6,000).

e-2: Cetyl myristate

(F) Inorganic Filler

f-1: Wollastonite (average particle size: 3 μm, and aspect ratio: 3).

[Evaluation Methods]

(1) Physical Properties Evaluation

Pellets obtained in each of the examples and comparative examples were dried at 80° C. for 3 hours and then molded into test pieces for physical properties evaluation under conditions of a mold temperature of 70° C. and a cooling time of 30 seconds by the use of a 5-ounce molding machine (IS-100E, mfd. by Toshiba Machine Co., Ltd.) set at a cylinder temperature of 200° C. Using the test pieces, the following tests were carried out.
1) Tensile strength and elongation; measured according to ASTM D638.
2) Flexural strength and flexural modulus; measured according to ASTM D790.
3) Izod impact strength; measured according to ASTM D256.
4) Peeling of a thin molded article Pellets obtained in each of the examples and comparative examples were dried at 80° C. for 3 hours and then molded into a spiral and thin molded article of 1 mm in thickness and 5 mm in width at a mold temperature of 80° C., a definite injection pressure and each of various injection speeds by the use of a 5-ounce molding machine (IS-100GN, mfd. by Toshiba Machine Co., Ltd.) set at a cylinder temperature of 200° C. (or 220° C. in the case of a system containing an inorganic filler). Peeling of the surface of the molded article was rated. A criterion for the rating is as follows:

⊚; not peeled at an injection speed of 80%.

◯; peeled at an injection speed of 80% or more.

Δ; peeled at an injection speed of 40% or more.

X; peeled at an injection speed of 20% or more.

(2) Loss Factor

Pellets obtained in each of the examples and comparative examples were dried at 80° C. for 3 hours and then molded into a dumbbell-shaped molded article (3.0 mm thick, 13 mm wide and 175 mm long) under conditions of a mold temperature of 70° C. and a cooling time of 30 seconds by the use of a 5-ounce molding machine (IS-100E, mfd. by Toshiba Machine Co., Ltd.) set at a cylinder temperature of 200° C. In an anechoic chamber, one end of this molded article was fixed and the base of the fixed end was struck with an impulse hammer. The radiated sound in this case was measured and the frequency response function of the vibrating force signal of the hammer and the sound pressure signal of a microphone was determined by the use of a sound analyzing system CF-5220 manufactured by Ono Sokki Co., Ltd. The higher the numerical value of the frequency response function, the higher the vibration-damping capability and the sound-damping capability.

(3) Sliding Capability

(a) Reciprocation Frictional Wear Test

Pellets obtained in each of the examples and comparative examples were dried at 80° C. for 3 hours and then molded into a flat plate of 3 mm in thickness as a test piece under conditions of a mold temperature of 70° C. and a cooling time of 20 seconds by the use of a 1-ounce molding machine (TI-30G, mfd. by Toyo Machinery & Metal Co., Ltd.) set at a cylinder temperature of 200° C. This test piece was reciprocated 5,000 times at 60° C. under a load of 2 kg at a linear speed of 30 mm/sec and a reciprocation distance of 20 mm under conditions suitable for heat generation under a high load by the use of a reciprocating frictional wear tester (AFT-15MS, mfd. by Toyo Seimitu K.K.), and the coefficient of friction and the depth of wear were measured. As a material on which the test piece was slid, a polyoxymethylene resin test piece (a cylindrical test piece with a R value at the tip of 2.5 mm and a diameter of 5 mm molded out of Tenack-C4520 manufactured by Asahi Kasei Corporation) was used.

(b) Shaft Hole Fusion Test

Pellets obtained in each of the examples and comparative examples were dried at 80° C. for 3 hours and then molded into a cylindrical pulley (inside diameter: 6 mm, outside diameter: 12 mm and height: 17 mm) as a test piece under conditions of a mold temperature of 40° C. or 60° C. and a cooling time of 12 seconds by the use of a 1-ounce molding machine (TI-30G2, mfd. by Toyo Machinery & Metal Co., Ltd.) set at a cylinder temperature of 200° C. A load was applied to this test piece by the use of a shaft hole sliding tester (a small-resin-bearing frictional wear tester manufactured by Shinko Engineering Co., Ltd.) at a linear speed of 92.7 mm/sec with definite intermissions (ON/OFF=60/30 sec) while being varied between OFF periods, and a load value at the time of fusion was determined. Tenack LA541T with an outside diameter of 6 mm was used as a fixed shaft.

(4) Sound-Damping Capability

A mating gear noise estimating machine (manufactured by Ohkura Industry Co., Ltd.) was operated under conditions of a number of revolution of 3,000 rpm, a torque of 150 kg-cm and a temperature of 23° C., and noises were measured with respect to measurement mode A characteristics (noises similar to those heard with human ears) in a noise measurement range of 50 Hz to 20 kHz by the use of a sound level meter manufactured by Ono Sokki Co., Ltd. Spur gears having a number of teeth of 50, a module of 0.6 and a pitch diameter of 30 mmΦ (were used for the measurement.

(5) Oil Resistance

The same cylindrical pulley (inside diameter: 6 mm, outside diameter: 12 mm and height: 17 mm) as used in the shaft hole fusion test was immersed in an olefin-based grease (Molykote PG641, a trade name, mfd. by Dow Corning Asia Ltd.) contained in a vessel, and was heat-treated in an oven at 50° C. for 500 hours. The external dimensions of the pulley were measured with a micrometer before and after the immersion in the grease, and the increment was calculated.

⊚; an increment in the dimension of 0 to less than 50 μm.

◯; an increment in the dimension of 50 to less than 100 μm.

Δ; an increment in the dimension of 100 to less than 200 μm.

X; an increment in the dimension of 200 to less than 300 μm.

X X; an increment in the dimension of 300 μm or more.

### EXAMPLE 1

45 Parts by weight of the polyoxymethylene resin as the component (a-1), 55 parts by weight of the polymer having at least one aromatic vinyl compound-conjugated diene compound random copolymer block as the component (b-1) and stabilizers, i.e., triethylene glycol-bis-[3-(3-t-butyl-5-methyl-4-hydroxyphenyl)propionate], polyamide 66 and calcium stearate in amounts of 0.3% by weight, 0.05% by weight and 0.10% by weight, respectively, based on the total weight of the component (a-1) and the component (b-1) were uniformly blended in a blender. Then, the blend was melt-kneaded by means of a 25 mmΦ twin-screw extruder (L/D=42) set at 200° C., at a number of screw revolution of 200 rpm and a rate of 10 kg/hr. The resin extruded was made into pellets with a strand cutter. Table 1 shows the results of various measurements using the pellets.

### EXAMPLE 2

The process of Example 1 was repeated except for changing the amount of the component (b-1) to 40 parts by weight and further adding 15 parts by weight of the olefin resin (c-1). Table 1 shows the results obtained.

### COMPARATIVE EXAMPLE 1

The process of Example 1 was repeated except for using 55 parts by weight of the component (c-1) in place of 55 parts by weight of the component (b-1). Table 1 shows the results obtained.

### COMPARATIVE EXAMPLE 2

The process of Example 1 was repeated except for using 55 parts by weight of the component (b-3) in place of 55 parts by weight of the component (b-1). Table 1 shows the results obtained.

### COMPARATIVE EXAMPLE 3

The process of Example 1 was repeated except for using 40 parts by weight of the component (b-3) in place of 40 parts by weight of the component (b-1) in Example 2. Table 1 shows the results obtained.

### EXAMPLE 3

The process of Example 1 was repeated except for further adding 5 parts by weight of the silicone-grafted polyolefin resin (d-1). Table 2 shows the results obtained.

### EXAMPLE 4

The process of Example 2 was repeated except for further adding 5 parts by weight of the silicone-grafted polyolefin resin (d-1). Table 2 shows the results obtained.

### EXAMPLE 5

The process of Example 4 was repeated except for further adding 2 parts by weight of the lubricant (e-1). Table 2 shows the results obtained.

### EXAMPLE 6

The process of Example 5 was repeated except for using 2 parts by weight of the component (e-2) in place of 2 parts by weight of the component (e-1). Table 2 shows the results obtained.

### COMPARATIVE EXAMPLE 4

The process of Example 3 was repeated except for using 55 parts by weight of the component (b-3) in place of 55 parts by weight of the component (b-1). Table 2 shows the results obtained.

### COMPARATIVE EXAMPLE 5

The process of Example 4 was repeated except for using 40 parts by weight of the component (b-3) in place of 40 parts by weight of the component (b-1). Table 2 shows the results obtained.

### EXAMPLES 7 and 8

The process of Example 4 was repeated except for changing the amounts of the components (b-1) and (c-1) to the amounts described in Table 3. Table 3 shows the results obtained.

### COMPARATIVE EXAMPLE 6

The process of Example 3 was repeated except for using 55 parts by weight of the component (c-1) in place of 55 parts by weight of the component (b-1). Table 3 shows the results obtained.

### EXAMPLES 9 and 10

The process of Example 4 was repeated except for using a combination of the component (c-1) and the component (c-2), or the component (c-2) in place of the component (c-1) as shown in Table 3. Table 3 shows the results obtained.

### EXAMPLE 11

The process of Example 4 was repeated except for using 40 parts by weight of the component (b-2) in place of 40 parts by weight of the component (b-1). Table 3 shows the results obtained.

### EXAMPLE 12

80 Parts by weight of the polyoxymethylene resin as the component (a-1), 20 parts by weight of the polymer having at least one aromatic vinyl compound-conjugated diene compound random copolymer block as the component (b-1), 3 parts by weight of the silicone-grafted polyolefin (d-1) and stabilizers, i.e., triethylene glycol-bis-[3-(3-t-butyl-5-methyl-4-hydroxyphenyl) propionate], polyamide 66 and calcium stearate in amounts of 0.3% by weight, 0.05% by weight and 0.10% by weight, respectively, based on the total weight of the component (a-1) and the component (b-1) were uniformly blended in a blender. Then, the blend was melt-kneaded by means of a 25 mmΦ twin-screw extruder (L/D=42) set at 200° C., at a number of screw revolution of 200 rpm and a rate of 10 kg/hr. The resin extruded was made into pellets with a strand cutter. Table 4 shows the results of measurements using the pellets.

### EXAMPLE 13

The process of Example 12 was repeated except for changing the amount of the component (b-1) to 15 parts by weight and further adding 5 parts by weight of the olefin resin (c-1). Table 4 shows the results obtained.

### EXAMPLE 14

The process of Example 13 was repeated except for using 40 parts by weight of the component (a-1) and 40 parts by weight of the component (a-2) in place of 80 parts by weight of the component (a-1). Table 4 shows the results obtained.

### EXAMPLE 15

The process of Example 13 was repeated except for using 80 parts by weight of the component (a-2) in place of 80 parts by weight of the component (a-1). Table 4 shows the results obtained.

### EXAMPLE 16

The process of Example 13 was repeated except for further adding 5 parts by weight of the component (f-1). Table 4 shows the results obtained.

### COMPARATIVE EXAMPLE 7

The process of Example 12 was repeated except for using 20 parts by weight of the component (b-3) in place of 20 parts by weight of the component (b-1). Table 4 shows the results obtained.

### COMPARATIVE EXAMPLE 8

The process of Example 12 was repeated except for using 15 parts by weight of the component (b-3) in place of 15 parts by weight of the component (b-1) in Example 13. Table 4 shows the results obtained.

TABLE 1

| | | | | Example- | Example- | Comparative | Comparative | Comparative |
|---|---|---|---|---|---|---|---|---|
| | | | | 1 | 2 | Example-1 | Example-2 | Example-3 |
| Compo- | (A) Polyoxymethylene | (a-1) (parts by weight) | | 45 | 45 | 45 | 45 | 45 |
| sition | resin | (a-2) (parts by weight) | | — | — | — | — | — |
| | (B) Polymer having | (b-1) (parts by weight) | | 55 | 40 | — | — | — |
| | at least one | (b-2) (parts by weight) | | — | — | — | — | — |
| | aromatic vinyl | (b-3) (parts by weight) | | — | — | — | 55 | 40 |
| | compound-conjugated | | | | | | | |
| | diene random | | | | | | | |
| | copolymer block | | | | | | | |
| | (C) Olefin resin | (c-1) (parts by weight) | | — | 15 | 55 | — | 15 |
| | (D) Silicone-grafted | (d-1) (parts by weight) | | — | — | — | — | — |
| | polyolefin resin | | | | | | | |
| | (E) Lubricant | (e-1) (parts by weight) | | — | — | — | — | — |
| | | (e-2) (parts by weight) | | — | — | — | — | — |
| | (F) Inorganic filler | (f-1) (parts by weight) | | — | — | — | — | — |
| Results | Physical properties | Tensile strength (MPa) | | 20 | 18 | 15 | 16 | 15 |
| | and the like | Tensile elongation (%) | | >200 | >200 | >200 | >200 | >200 |
| | | Flexural strength (MPa) | | 18 | 16 | 13 | 14 | 14 |
| | | Flexural modulus (MPa) | | 510 | 470 | 320 | 440 | 420 |
| | | Izod impact strength (J/m) | | 90 | 110 | 340 | 86 | 250 |
| | | Peeling of molded article | | ◯ | ◯ | ◯ | ◯ | ◯ |
| | | Loss factor (%) | 23° C. | 14 | 13 | 3 | 32 | 18 |
| | | | 60° C. | 11 | 11 | 5 | 20 | 14 |
| | | Sound-damping capability (dB) | | 58 | 56 | 62 | 58 | 58 |
| | | Oil resistance | | ⊚ | ◯ | X X | X | X |
| | Sliding properties | Reciprocation | Coefficient of | 0.60 | 0.52 | 0.74 | 0.70 | 0.68 |
| | on POM | frictional | friction (μ) | | | | | |
| | | wear test | 60° C., | | | | | |
| | | | 5,000 times | | | | | |
| | | | Depth of wear | 420 | 270 | 680 | 750 | 700 |
| | | | (μm) 60° C., | | | | | |
| | | | 5,000 times | | | | | |
| | | Shaft hole | Load at fusion | 0.3 | 0.7 | 0.5 | 0.1 | 0.2 |
| | | fusion test | (kg) | | | | | |

TABLE 2

| | | | | Example- | Example- | Example- | Example- | Comparative | Comparative |
|---|---|---|---|---|---|---|---|---|---|
| | | | | 3 | 4 | 5 | 6 | Example-4 | Example-5 |
| Compo- | (A) Polyoxymethylene | (a-1) (parts by weight) | | 45 | 45 | 45 | 45 | 45 | 45 |
| sition | resin | (a-2) (parts by weight) | | — | — | — | — | — | — |
| | (B) Polymer having | (b-1) (parts by weight) | | 55 | 40 | 40 | 40 | — | — |
| | at least one | (b-2) (parts by weight) | | — | — | — | — | — | — |
| | aromatic vinyl | (b-3) (parts by weight) | | — | — | — | — | 55 | 40 |
| | compound-conjugated | | | | | | | | |
| | diene random | | | | | | | | |
| | copolymer block | | | | | | | | |
| | (C) Olefin resin | (c-1) (parts by weight) | | — | 15 | 15 | 15 | — | 15 |
| | | (c-2) (parts by weight) | | — | — | — | — | — | — |
| | (D) Silicone-grafted | (d-1) (parts by weight) | | 5 | 5 | 5 | 5 | 5 | 5 |
| | polyolefin resin | | | | | | | | |
| | (E) Lubricant | (e-1) (parts by weight) | | — | — | 2 | — | — | — |
| | | (e-2) (parts by weight) | | — | — | — | 2 | — | — |
| | (F) Inorganic filler | (f-1) (parts by weight) | | — | — | — | — | — | — |
| Results | Physical properties | Tensile strength (MPa) | | 20 | 16 | 15 | 15 | 15 | 17 |
| | and the like | Tensile elongation (%) | | >200 | >200 | >200 | >200 | >200 | >200 |
| | | Flexural strength (MPa) | | 17 | 15 | 15 | 15 | 13 | 14 |
| | | Flexural modulus (MPa) | | 500 | 420 | 410 | 441 | 350 | 430 |
| | | Izod impact strength (J/m) | | 100 | 105 | 110 | 120 | 340 | 130 |
| | | Peeling of molded article | | ◯ | ◯ | ◯ | ◯ | ◯ | ◯ |
| | | Loss factor (%) | 23° C. | 15 | 12 | 12 | 12 | 30 | 18 |
| | | | 60° C. | 11 | 11 | 11 | 11 | 19 | 14 |
| | | Sound-damping capability (dB) | | 52 | 51 | 51 | 50 | 54 | 53 |
| | | Oil resistance | | ⊚ | ◯ | ◯ | ◯ | X | X |
| | Sliding properties | Reciprocation | Coefficient of | 0.30 | 0.20 | 0.18 | 0.19 | 0.34 | 0.19 |
| | on POM | frictional | friction (μ) | | | | | | |
| | | wear test | 60° C., | | | | | | |
| | | | 5,000 times | | | | | | |
| | | | Depth of wear | 100 | 98 | 78 | 86 | 360 | 132 |
| | | | (μm) 60° C., | | | | | | |
| | | | 5,000 times | | | | | | |
| | | Shaft hole | Load at fusion | 1.0 | 1.2 | 1.4 | 1.3 | 0.3 | 0.4 |
| | | fusion test | (kg) | | | | | | |

TABLE 3

| | | | | Example- | Example- | Comparative | Example- | Example- | Example- |
|---|---|---|---|---|---|---|---|---|---|
| | | | | 7 | 8 | Example-6 | 9 | 10 | 11 |
| Compo- | (A) Polyoxymethylene | (a-1) (parts by weight) | | 45 | 45 | 45 | 45 | 45 | 45 |
| sition | resin | (a-2) (parts by weight) | | — | — | — | — | — | — |
| | (B) Polymer having | (b-1) (parts by weight) | | 25 | 15 | — | 40 | 40 | — |
| | at least one | (b-2) (parts by weight) | | — | — | — | — | — | 40 |
| | aromatic vinyl | (b-3) (parts by weight) | | — | — | — | — | — | — |
| | compound-conjugated | | | | | | | | |
| | diene random | | | | | | | | |
| | copolymer block | | | | | | | | |
| | (C) Olefin resin | (c-1) (parts by weight) | | 30 | 40 | 55 | 7.5 | — | — |
| | | (c-2) (parts by weight) | | — | — | — | 7.5 | 15 | 15 |
| | (D) Silicone-grafted | (d-1) (parts by weight) | | 5 | 5 | 5 | 5 | 5 | 5 |
| | polyolefin resin | | | | | | | | |
| | (E) Lubricant | (e-1) (parts by weight) | | — | — | — | — | — | — |
| | | (e-2) (parts by weight) | | — | — | — | — | — | — |
| | (F) Inorganic filler | (f-1) (parts by weight) | | — | — | — | — | — | — |
| Results | Physical properties | Tensile strength (MPa) | | 16 | 15 | 14 | 16 | 16 | 16 |
| | and the like | Tensile elongation (%) | | >200 | >200 | >200 | >200 | >200 | >200 |
| | | Flexural strength (MPa) | | 14 | 13 | 12 | 15 | 14 | 14 |
| | | Flexural modulus (MPa) | | 390 | 350 | 310 | 420 | 400 | 410 |
| | | Izod impact strength (J/m) | | 120 | 180 | 340 | 98 | 90 | 110 |
| | | Peeling of molded article | | ◯ | ◯ | ◯ | ◯ | ◯ | ◯ |
| | | Loss factor (%) | 23° C. | 9 | 5 | 3 | 12 | 12 | 13 |
| | | | 60° C. | 9 | 8 | 7 | 11 | 11 | 11 |
| | | Sound-damping capability (dB) | | 52 | 56 | 62 | 51 | 52 | 51 |
| | | Oil resistance | | Δ | X | X X | ◯ | ◯ | ◯ |
| | Sliding properties | Reciprocation | Coefficient of | 0.21 | 0.21 | 0.23 | 0.20 | 0.21 | 0.19 |
| | on POM | frictional | friction (μ) | | | | | | |
| | | wear test | 60° C., | | | | | | |
| | | | 5,000 times | | | | | | |
| | | | Depth of wear | 120 | 180 | 360 | 100 | 110 | 100 |
| | | | (μm) 60° C., | | | | | | |
| | | | 5,000 times | | | | | | |
| | | Shaft hole | Load at fusion | 1.0 | 0.9 | 0.8 | 1.2 | 1.2 | 1.2 |
| | | fusion test | (kg) | | | | | | |

TABLE 4

| | | | | | | | | | Compar- | Compar- |
|---|---|---|---|---|---|---|---|---|---|---|
| | | | | Example- | Example- | Example- | Example- | Example- | ative Ex- | ative Ex- |
| | | | | 12 | 13 | 14 | 15 | 16 | ample-7 | ample-8 |
| Compo- | (A) Polyoxymethylene | (a-1) (parts by weight) | | 80 | 80 | 40 | — | 80 | 80 | 80 |
| sition | resin | (a-2) (parts by weight) | | — | — | 40 | 80 | — | — | — |
| | (B) Polymer having | (b-1) (parts by weight) | | 20 | 15 | 15 | 15 | 15 | — | — |
| | at least one | (b-2) (parts by weight) | | — | — | — | — | — | — | — |
| | aromatic vinyl | (b-3) (parts by weight) | | — | — | — | — | — | 20 | 15 |
| | compound-conjugated | | | | | | | | | |
| | diene random | | | | | | | | | |
| | copolymer block | | | | | | | | | |
| | (C) Olefin resin | (c-1) (parts by weight) | | — | 5 | 5 | 5 | 5 | — | 5 |
| | | (c-2) (parts by weight) | | — | — | — | — | — | — | — |
| | (D) Silicone-grafted | (d-1) (parts by weight) | | 3 | 3 | 3 | 3 | 3 | 3 | 3 |
| | polyolefin resin | | | | | | | | | |
| | (E) Lubricant | (e-1) (parts by weight) | | — | — | — | — | — | — | — |
| | | (e-2) (parts by weight) | | — | — | — | — | — | — | — |
| | (F) Inorganic filler | (f-1) (parts by weight) | | — | — | — | — | 5 | — | — |
| Results | Physical properties | Tensile strength (MPa) | | 31 | 28 | 32 | 36 | 40 | 31 | 29 |
| | and the like | Tensile elongation (%) | | 82 | 74 | 60 | 56 | 44 | 100 | 110 |
| | | Flexural strength (MPa) | | 50 | 44 | 52 | 55 | 60 | 48 | 44 |
| | | Flexural modulus (MPa) | | 1520 | 1000 | 1300 | 1500 | 1200 | 1500 | 1340 |
| | | Izod impact strength (J/m) | | 45 | 48 | 45 | 35 | 31 | 55 | 59 |
| | | Peeling of molded article | | ◯ | ◯ | ◯ | Δ | ◯ | ◯ | ◯ |
| | | Loss factor (%) | 23° C. | 5 | 5 | 5 | 5 | 5 | 8 | 8 |
| | | | 60° C. | 8 | 9 | 9 | 8 | 8 | 10 | 9 |
| | | Sound-damping capability (dB) | | 58 | 57 | 58 | 63 | 59 | 62 | 61 |
| | | Oil resistance | | ⊚ | ⊚ | ⊚ | ⊚ | ⊚ | ⊚ | ⊚ |
| | Sliding properties | Reciprocation | Coefficient of | 0.14 | 0.15 | 0.19 | 0.21 | 0.14 | 0.37 | 0.36 |
| | on POM | frictional wear | friction (μ) | | | | | | | |
| | | test | 60° C., | | | | | | | |
| | | | 5,000 times | | | | | | | |
| | | | Depth of wear | 60 | 80 | 90 | 130 | 70 | 230 | 200 |
| | | | (μm) 60° C., | | | | | | | |
| | | | 5,000 times | | | | | | | |
| | | Shaft hole | Load at fusion | 1.9 | 2.2 | 1.9 | 1.7 | 2.4 | 1.3 | 1.5 |
| | | fusion test | (kg) | | | | | | | |

### INDUSTRIAL APPLICABILITY

The invention provides a composition obtained by imparting excellent flexibility, vibration-damping and sound-damping properties and frictional wear properties under a heavy load and oil resistance to a polyoxymethylene resin. At least one part selected from the group consisting of a working part(s) (at least one member selected from the group consisting of gears, cams, sliders, levers, arms, clutches, joints, shafts, bearings, key stems and key tops), resin parts of outsert chassis, chassis, trays and side plates, which are obtained by molding, cutting, or both molding and cutting of the above-mentioned composition, is used for the following purposes.
(1) Parts used in OA appliances represented by printers and copying machines.
(2) Parts used in video appliances represented by VTR and video movies.
(3) Parts used in music, image or information appliances represented by cassette players, LD, MD, CD
(including CD-ROM, CD-R and CD-RW), DVD (including DVD-ROM, DVD-R, DVD-RAM and DVD-Audio), navigation systems and mobile computers.
(4) Parts used in communication appliances represented by mobile phones and facsimile telegraphs.
(5) Parts used in clips, through anchors, tongues, fuel tank and parts around them, which are used as interior and exterior automobile trims.
(6) Parts used in industrial sundries represented by disposable cameras, toys, fasteners, conveyers, buckles and house equipment appliances.

1. A polyoxymethylene resin composition comprising
(A) a polyoxymethylene resin;
(B) a polymer having at least one block made of a hydrogenated aromatic vinyl compound-conjugated diene compound random copolymer having the main dispersion peak of tan δ at 60° C. or below in the viscoelastic spectrum, and optionally
(C) a polyolefin resin, wherein the amount of (A) ranges from 10 to 99.5 parts by weight and the total amount of (B) and (C) ranges from 0.5 to 90 parts by weight, each per 100 parts by weight of the sum of (A), (B) and (C), and the (B)/(C) weight ratio ranges from 100/0 to 20/80.

2. A polyoxymethylene resin composition according to claim 1, which further comprises (D) a silicone-grafted polyolefin resin in an amount of 0.1 to 30 parts by weight per 100 parts by weight of the sum of (A), (B) and (C).

3. A polyoxymethylene resin composition according to claim 1, which further comprises (E) a lubricant and/or (F) an inorganic filler in amounts of 0.05 to 20 parts by weight and 0.1 to 150 parts by weight, respectively, per 100 parts by weight of the sum of (A), (B) and (C).

4. A polyoxymethylene resin composition according to claim 1 or 2, wherein the polyoxymethylene resin of component (A) comprises a polyoxymethylene block copolymer (A-1) having a number average molecular weight of 10,000 to 500,000 and represented by the following formula (1): 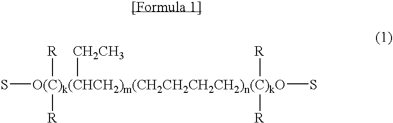
wherein the portion other than S (hereinafter referred to as the block T) is a hydrogenated liquid polybutadiene residue having a hydroxyalkyl group at each end and having a number average molecular weight of 500 to 10,000 in which m=2 to 98% by mole, n=2 to 98% by mole, m+n=100% by mole and the repeating units in an amount of m are present at random or in the form of a block(s) with respect to the repeating units in an amount of n, and the block T may be one which has unsaturated bonds and has an iodine number of 20 g−I₂/100 g or less; each of two k's, which may be the same or different, is an integer selected in the range of 2 to 6; each of R's, which may be the same or different, is a group selected from the group consisting of hydrogen, alkyl groups, substituted alkyl groups, aryl groups and substituted aryl groups; and the block S is a polyoxymethylene copolymer residue represented by the following formula (2): 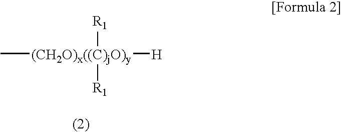
wherein each of R₁'s, which may be the same or different, is a group selected from the group consisting of hydrogen, alkyl groups, substituted alkyl groups, aryl groups and substituted aryl groups; j is an integer selected in the range of 2 to 6; x=95 to 99.9% by mole, y=5 to 0.1% by mole, x+y=100% by mole; the repeating units in an amount of y are present at random with respect to the repeating units in an amount of x; and the average of the number average molecular weights of the two blocks S in the formula (1) is 5,000 to 250,000.

5. A polyoxymethylene resin composition according to claim 4, wherein as the polyoxymethylene resin of component (A), the above-mentioned copolymer (A-1) and a polyoxymethylene copolymer (A-2) comprising oxymethylene groups as its main repeating units and comprising oxyalkylene groups of 2 or more carbon atoms in an amount of 0.1 to 10% by mole based on the number of moles of the oxymethylene groups are used in combination, and the (A-1)/(A-2) weight ratio of the polyoxymethylene block copolymer (A-1) to the polyoxymethylene copolymer (A-2) is 10 or more and less than 100.

6. A polyoxymethylene resin composition according to claim 4, wherein the polymer having at least one block made of a hydrogenated aromatic vinyl compound-conjugated diene compound random copolymer of component (B) is a block copolymer comprising at least one polymer block B1 composed mainly of aromatic vinyl compound units (the content of aromatic vinyl compound units: at least 90% by weight) and at least one aromatic vinyl compound-conjugated diene compound random copolymer block B2 (the content of aromatic vinyl compound units: less than 90% by weight and not less than 3% by weight),
the content of aromatic vinyl compound units ranges from 50 to 90% by weight and the main dispersion peak of tan δ in the viscoelastic spectrum is at a temperature in the range of 60° C. to −30° C.

7. A polyoxymethylene resin composition according to claim 6, wherein the polyolefin resin of component (C) is a modified product obtained by modification with an α,β-unsaturated carboxylic acid and/or an acid anhydride thereof.

8. A molded or shaped article obtained by molding, cutting, or both molding and cutting of a polyoxymethylene resin composition according to claim 1 or 2.

9. A polyoxymethylene resin composition according to claim 3, wherein the polyoxymethylene resin of component (A) comprises a polyoxymethylene block copolymer (A-1) having a number average molecular weight of 10,000 to 500,000 and represented by the following formula (1): 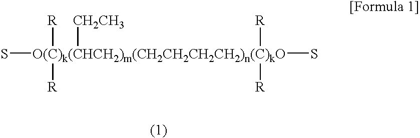
wherein the portion other than S (hereinafter referred to as the block T) is a hydrogenated liquid polybutadiene residue having a hydroxyalkyl group at each end and having a number average molecular weight of 500 to 10,000 in which m=2 to 98% by mole, n=2 to 98% by mole, m+n=100% by mole and the repeating units in an amount of m are present at random or in the form of a block(s) with respect to the repeating units in an amount of n, and the block T may be one which has unsaturated bonds and has an iodine number of 20 g−I₂/100 g or less; each of two k's, which may be the same or different, is an integer selected in the range of 2 to 6; each of R's, which may be the same or different, is a group selected from the group consisting of hydrogen, alkyl groups, substituted alkyl groups, aryl groups and substituted aryl groups; and the block S is a polyoxymethylene copolymer residue represented by the following formula (2): 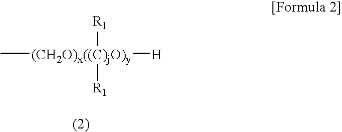
wherein each of R₁'s, which may be the same or different, is a group selected from the group consisting of hydrogen, alkyl groups, substituted alkyl groups, aryl groups and substituted aryl groups; j is an integer selected in the range of 2 to 6; x=95 to 99.9% by mole, y=5 to 0.1% by mole, x+y=100% by mole; the repeating units in an amount of y are present at random with respect to the repeating units in an amount of x; and the average of the number average molecular weights of the two blocks S in the formula (1) is 5,000 to 250,000.

10. A polyoxymethylene resin composition according to claim 9, wherein as the polyoxymethylene resin of component (A), the above-mentioned copolymer (A-1) and a polyoxymethylene copolymer (A-2) comprising oxymethylene groups as its main repeating units and comprising oxyalkylene groups of 2 or more carbon atoms in an amount of 0.1 to 10% by mole based on the number of moles of the oxymethylene groups are used in combination, and the (A-1)/(A-2) weight ratio of the polyoxymethylene block copolymer (A-1) to the polyoxymethylene copolymer (A-2) is 10 or more and less than 100.

11. A polyoxymethylene resin composition according to claim 9, wherein the polymer having at least one block made of a hydrogenated aromatic vinyl compound-conjugated diene compound random copolymer of component (B) is a block copolymer comprising at least one polymer block B1 composed mainly of aromatic vinyl compound units (the content of aromatic vinyl compound units: at least 90% by weight) and at least one aromatic vinyl compound-conjugated diene compound random copolymer block B2 (the content of aromatic vinyl compound units: less than 90% by weight and not less than 3% by weight),
the content of aromatic vinyl compound units ranges from 50 to 90% by weight and the main dispersion peak of tan δ in the viscoelastic spectrum is at a temperature in the range of 60° C. to −30° C.

12. A polyoxymethylene resin composition according to claim 11, wherein the polyolefin resin of component (C) is a modified product obtained by modification with an α,β-unsaturated carboxylic acid and/or an acid anhydride thereof.

13. A molded or shaped article obtained by molding, cutting, or both molding and cutting of a polyoxymethylene resin composition according to claim 3.
